(19) United States
(12) Patent Application Publication
(10) Pub. No.: US 2026/0259957 A1
(43) Pub. Date: Sep. 3, 2026

(54) CLUSTERIZATION OF NMR 2D MAPS USING WATER LEVEL SEPARATION METHOD & AUTOMATED FLUID INTERPRETATION USING FLUID INTERPRETATION MASK

(71) Applicant: Schlumberger Technology Corporation, Sugar Land, TX (US)

(72) Inventors: George Alexis Bordakov, Sugar Land, TX (US); Evgeny Karpekin, Sugar Land, TX (US)

(21) Appl. No.: 19/535,167

(22) Filed: Feb. 10, 2026

Related U.S. Application Data
(60) Provisional application No. 63/757,563, filed on Feb. 12, 2025.
(60) Provisional application No. 63/787,475, filed on Apr. 11, 2025.
(60) Provisional application No. 63/787,538, filed on Apr. 11, 2025.

(51) Int. Cl. G06F 18/2133; G06V 10/74; G06V 10/762; G06V 10/766

(52) U.S. Cl. CPC G06F 18/2133; G06V 10/761; G06V 10/762; G06V 10/766

(57) ABSTRACT

Aspects describe methods and apparatus to evaluate nuclear magnetic resonance data maps to identify structures and fluids within a geological stratum or series of geological stratum in an automatic fashion.

### CROSS-REFERENCE TO RELATED APPLICATIONS

The present application claims priority to U.S. Provisional Application 63/757,563 dated Feb. 12, 2025, the entirety of which is incorporated by reference. The present application also claims priority to U.S. Provisional Application 63/787,475 dated Apr. 11, 2025, the entirety of which is incorporated by reference. The present application also claims priority to U.S. Provisional Application 63/787,538 dated Apr. 11, 2025, the entirety of which is incorporated by reference.

### FIELD OF THE DISCLOSURE

Aspects of the disclosure relate to nuclear magnetic resonance (NMR) evaluation of geological structures. More specifically, aspects of the disclosure relate to evaluation of two-dimensional NMR maps using water separation and fluid interpretation mask techniques.

### BACKGROUND

One objective of formation evaluation for unconventional reservoirs is to estimate reservoir quality by quantifying volumes of different fluid components. Nuclear magnetic resonance (NMR) logging tools have the capability and sensitivity to partition the total hydrocarbon and total water volumes residing in the pore space of the rock under evaluation into fluid components non-movable (bound) in the rock and the ones potentially producible from the rock based on their properties and location in the pore space. These tools add valuable information, allowing scientists to estimate the total organic carbon in a reservoir. These may be used together with nuclear spectroscopy-based tools capable to estimate the total organic carbon in a reservoir as well as with resistivity and dielectric tools sensitive to the water-filled porosity.

Multi-wait time NMR measurements provide the most complete fluid components characterization information. These measurements use special data acquisition schemes that directly encode T1 and T2 information in the data, which are then inverted into T1-T2 maps. T1-T2 maps from NMR logging tools show unique signatures for hydrocarbons, such as gas, bitumen, and producible and bound oil. Likewise, capillary and clay-bound water, and water in larger pores are characterized by different signatures. These signatures indicate properties of the fluids, properties of the rock, and the geometrical configuration of fluid phases within the pore space. These may be investigated both visually as well as automatically using various data science techniques. By improving existing interpretation algorithms through reducing the number of adjusted parameters, the quality and definition of the NMR maps may be improved.

Automatic fluid properties determination from the maps delivering robust results is of extreme importance in the industry. Industry players; therefore, are making strides in improving existing interpretation algorithms by reduction of the number of parameters to be adjusted and making it more welcoming to improvement of the quality and definition of the NMR maps.

There is a need to provide alternative methods for evaluation of NMR data to accurately predict subsurface features and properties.

There is a further need to provide alternative methods that are easy to comprehend and that can be performed automatically.

There is a still further need to provide alternative methods that are economically beneficial to the overall wellbore development and hydrocarbon extraction plans.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are; therefore, not to be considered limiting of its scope, for the disclosure may admit to other equally effective embodiments without specific recitation. Accordingly, the following summary provides just a few aspects of the description and should not be used to limit the described embodiments to a single concept.

In one example embodiment, a method for analyzing a two dimensional nuclear resonance map is disclosed. The method may comprise choosing a dataset as a reference. The method may further comprise performing blind source separation with non-negative matrix factorization, followed by water level separation on the reference dataset. The method may further comprise calculating residual misfits for each number factor. The method may further comprise analyzing the calculated residual misfits. The method may further comprise determining a recommended number of factors. The method may further comprise calculating confidence intervals for the calculated residual misfits. The method may further comprise comparing the calculated residual misfits with the calculated confident intervals. The method may further comprise determining non-negative weights for the determined blind source separation factors and feasibly water level separation clusters.

In another example embodiment, a method is disclosed. The method may comprise performing a blind source separation technique for a different number of factors. The method may further comprise calculating residual misfits for the different number of factors, wherein several types of misfit characteristics in addition to residual variance are calculated. The method may further comprise estimating a number of factors for each type of misfit characteristics via exhausting the entire useful signal. The method may further comprise computing a misfit linear regression for the number of factors corresponding to noise with regression confidence intervals. The method may further comprise based on the regression confidence intervals, separating factors corresponding to fluids from the factors corresponding to noise. The method may further comprise estimating a proper number of factors for each type of misfit characteristic. The method may further comprise analyzing failures from the estimated proper number of factors. The method may further comprise combining all non-failed proper number of factors for all misfit types with one of refined and non-refined factors.

In another example embodiment, a method is disclosed. The method may comprise loading a map as two-dimensional array of shape. The method may further comprise raveling the array into a one-dimensional array of shape. The method may further comprise sorting the array by values from highest to lowest. The method may further comprise sorting an array of original coordinates by a same sorting order as the sorting of the array by values from highest to lowest. The method may further comprise iterating, in a loop, through all remaining pair-values in the original coordinate array. The method may further comprise taking next point-candidates from the original coordinate array. The method may further comprise calculating a Euclidean distance between a new 2-value coordinate point candidate to all coordinate points in a summit array. The method may further comprise determining if the Euclidean distances calculated are greater than a square root of 2, and when such determination is true, then noting that a candidate is not adjacent to any previously identified island-summits and when the Euclidean distances calculated are not true, proceeding to a next point in the array of original coordinates. The method may further comprise inferring a number of identified clusters. The method may further comprise allocating an empty array for each identified cluster. The method may further comprise populating every identified cluster with a single point-coordinate of a cluster summit from a summit array. The method may further comprise iterating through all points in the original coordinate array to produce results.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted; however, that the appended drawings illustrate only typical embodiments of this disclosure and are therefore not be considered limiting of its scope, for the disclosure may admit to other equally effective embodiments.

FIG. 1 shows a representation of matrix factorization used in a blind source separation (BSS) algorithm, according to one or more examples of the disclosure.

FIG. 2 illustrates a BSS process, according to one or more examples of the disclosure.

FIG. 3 shows a BSS analysis process (Panel-C) of two synthetic sources whereas (Panels-A and B) provide mixed variable proportions along a depth of analysis according to one or more examples of the disclosure.

FIG. 4 shows four basis-maps after factorization of a synthetic data set (top 1-4) and clustering signals from four basis-maps by voting algorithm (bottom), according to one or more examples of the disclosure.

FIG. 5 shows an example of non-physical clustering with disconnected areas of a same cluster (top) and an example of good clustering with all clusters being connected and with centroids being part of the corresponding clusters (bottom), according to one or more examples of the disclosure.

FIG. 6 shows examples of depth-by-depth T1-T2 maps. On the left, high definition (new processing), and on the right, standard definition (old processing), according to one or more examples of the disclosure.

FIG. 7 shows the summit point and adjacent points within maximum Euclidean distance from the summit, according to one or more examples of the disclosure.

FIG. 8 shows the operation of a weighted least squares (WLS) algorithm original T1-T2 map (left), summits of four clusters/islands identified (middle), and all points on T1-T2 map (right), are accreted to one of four clusters seeded by their summits, according to one or more examples of the disclosure.

FIG. 9 shows a representation of fluid interpretation mask (FIM): blue-nonphysical area; grey-clay bound water, green-bound hydrocarbon (bitumen), light blue-small pores water, cyan-big pores water, light green-small pores oil (oil in organic matter pores), orange-big pores oil (oil in interparticle pores), according to one or more examples of the disclosure.

FIG. 10 is a graph illustrating positions of the centers of the Gaussian fluid signatures in the synthetic dataset analyzed in this section. Labels sequentially denote name, T2, and T1 (both in ms) of a fluid and blue lines indicate constraints of the inversion.

FIG. 11 is an illustration of a model T1-T2 map of the synthetic dataset (top) and inversion result at the same depth (bottom). Only 3 fluids: CBW, WIR0, and OFR0, are present at that depth.

FIG. 12 is a series of graphs illustrating misfits calculated for the synthetic dataset. N=12 (expected proper factors number) is denoted by red dot.

FIG. 13 illustrates misfit plots from FIG. 12 zoomed in the transition zone.

FIG. 14 is a graph illustrating evaluation of the cutoff line increment for R_{N}⁵⁰. “Signal” bars correspond to decrements before transition to noise. “Noise” bars correspond to decrements after transition. Median is shown by the solid red line.

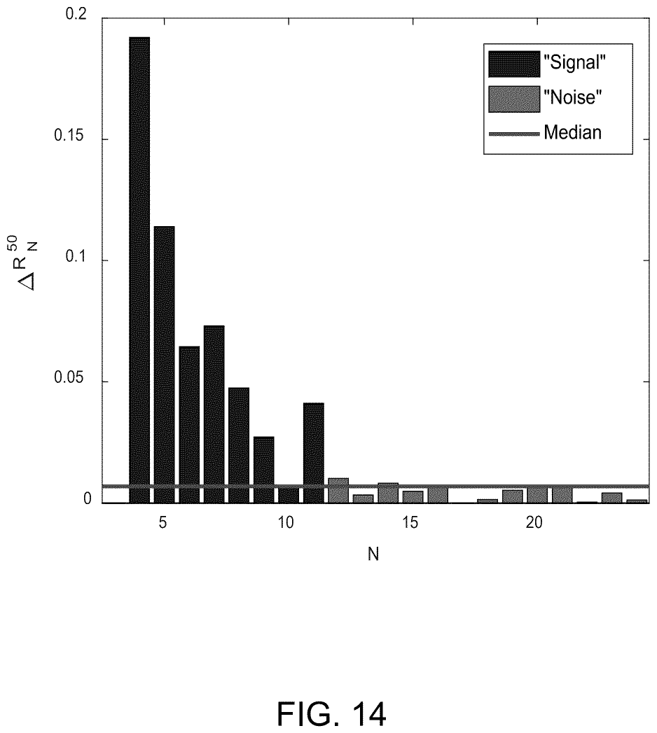

FIG. 15 is a series of graphs illustrating determination of the recommended number of factors N* with cutoff line Λ(N) for the synthetic dataset.

FIG. 16 is a series of graphs illustrating determination of the recommended number of factors for synthetic and field data with cutoff line.

FIG. 17 is a series of graphs illustrating determination of the recommended number of factors for synthetic and field data with linear regression confidence level boundary.

FIG. 18 is a series of graphs illustrating determination of the recommended number of factors for synthetic and field data with linear regression confidence level boundary with \tilde{R}_{N}⁵⁰ misfit calculated for refined BSS factors.

FIG. 19 is a series of graphs illustrating BSS and refined misfits for the synthetic data used to make FIG. 10.

FIG. 20 is a series of graphs illustrating BSS and refined misfits for the field data to make FIG. 10.

FIG. 21 is a series of graphs illustrating BSS and refined misfits for the field data in case of improper refinement.

FIG. 22 is a series of graphs illustrating failure of R_{N}⁵⁰ values.

FIG. 23 is a series of graphs illustrating determination of the recommended number of factors for synthetic and field data with linear regression confidence level boundary.

FIG. 24 is a series of images illustrating projection of the reference dataset BSS factors into new maps on depth-by-depth basis.

FIG. 25 is a series of graphs illustrating analysis of misfits demonstrates success of the application of reference set determined factors for a new well.

FIG. 26 is a series of graphs illustrating analysis of misfits demonstrates that reference set determined factors cannot be used for the entire new well.

FIG. 27 is a series of graphs illustrating a comparison of per-depth misfit with upper confidence level for 90th percentile misfit for the data of FIG. 15.

FIG. 28 a first example method in accordance with one example embodiment of the disclosure.

FIG. 29 a second example method in accordance with one example embodiment of the disclosure.

FIG. 30 a third example method in accordance with one example embodiment of the disclosure.

To facilitate understanding, identical reference numerals have been used, where possible, to designate identical elements that are common to the figures (“FIGS”). It is contemplated that elements disclosed in one embodiment may be beneficially utilized on other embodiments without specific recitation.

### DETAILED DESCRIPTION

In the following, reference is made to embodiments of the disclosure. It should be understood; however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers, and/or sections, these elements, components, regions, layers, and/or sections should not be limited by these terms. These terms may be only used to distinguish one element, components, region, layer, or section from another region, layer, or section. Terms such as “first”, “second”, and other numerical terms, when used herein, do not imply a sequence or order unless clearly indicated by the context. Thus, a first element, component, region, layer, or section discussed herein could be termed a second element, component, region, layer, or section without departing from the teachings of the example embodiments.

When an element or layer is referred to as being “on”, “engaged to,”, “connected to”, or “coupled to” another element or layer, it may be directly on, engaged, connected to, or coupled to the other element or layer, or interleaving elements or layers may be present. In contrast, when an element is referred to as being “directly on”, “directly engaged to”, “directly connected to”, or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood; however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

Embodiments of the disclosure may provide for an article of manufacture that contains a non-transitory memory product. The non-transitory memory product may be configured to retain data, such as method steps. The non-transitory memory product may store data and be read by a device. Such devices may be computing devices such as a laptop computer, main frame computer, computer, cell phone, or other similar device. The method steps may be used, for example, to control a computer or perform mathematical calculations. In turn, the computer may instruct other systems, machines or components. Example non-transitory memory products may include universal serial bus devices, solid state memory arrangements, compact discs, or computer hard drives. In some instances, the non-transitory device may be configured with a device that reads the stored information and transmits the data to a separate location. In some embodiments, artificial intelligence may be used in conjunction with the data stored on the article of manufacture to perform various functions.

Further embodiments may include methodologies that allow computers to be trained to allow for more comprehensive and accurate answers. Such training may be performed in nodes that may be used to allow for fine tuning of results. Upon retention of results of calculations, the method steps may be altered such that results that are not accurate are precluded from future calculations by amending method steps accomplished in various nodes. Such alterations are contemplated and are within the scope of this disclosure.

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the specific goals, such as compliance with system related and business related constraints, which will vary from one implementation to another. Moreover, it will be appreciated that such a development effort, even if complex and time-consuming, would be a routine undertaking for those of ordinary skill in the art having the benefit of this disclosure.

Certain aspects of the present disclosure relate to computation of weights corresponding to previously established blind source separation (BSS) factors and possibly water level separation (WLS) clusters for newly acquired set of NMR maps with subsequent computation of misfits and comparison of these misfits with previously established misfits' confidence intervals.

The BSS process has gained success in the fluid properties determination. BSS has been used in conjunction with analysis of variance and offered a procedure of gradual refining of the interpretation details by increasing the share of variance explained by the factor analysis.

Subsequent to its discovery, BSS gained success in the analysis of fluid properties in geological settings. Conventionally, BSS has been used in conjunction with analysis of variance. The results have offered a procedure of gradual refining of the interpretation details by increasing the share of variance explained by the factor analysis.

BSS has a well-known limitation. When NMR logs contain depths where one or more of the fluids is dominant, with volume fraction close to 100 percent, BSS performs well. BSS; however, may give inadequate results when the fluid volume fraction dynamic range is not large enough. This and other shortcomings are overcome by introducing post-BSS clustering in conjunction with a technique to determine maximum likelihood of a number of clusters. This method provides successful results using previous standard-definition T1-T2 inversions.

While being very powerful, the above techniques require adjustment of quite large numbers of algorithm parameters. Such adjustment can be difficult. With the introduction of high definition T1-T2 maps, automatic interpretation of high-definition maps has not been possible and has raised many complaints from field personnel. The above methods lack the natural ability to go further into the interpretation details through increasing the share of the explained variance.

Conventionally, there are 2 approaches to interpret T1-T2 maps. The first approach is based on depth-by-depth analysis of individual maps. With the help of several static cutoff lines defined for the entire zone of analysis, the area of a map is partitioned into several segments, and porosity distribution within each segment of each map is summed into corresponding volumes at each depth. Finally, segment volume channels are interpreted in terms of fluid types based on the relative position of a segment along T1-T2 coordinates. The drawback of such an approach is the definition of the cutoff lines with respect to variables along depth signal patterns in T1-T2 maps. At some depths there may appear to be linear separation of different signal clusters on a map that are associated with specific fluids. At other depths, a signal cluster may fall onto an adjacent segment cutoff line resulting in a failed analysis. In these approaches, information about signal evaluation along a depth or a series of depths is not considered at all.

A second approach may be used for analysis. This second approach is an interpretation method that analyzes all T1-T2 maps from the whole zone of interest at once. This approach uses variability of the signal pattern on T1-T2 maps along the depth to extract a position of the “true” fluid sources. This methodology can simultaneously analyze the T1-T2 maps from the whole target zone interval of a single well or multiple wells, and allows for defining a set of “basis” T1-T2 maps (factors or sources), whose weighted sum reproduces any of the input maps with a specified degree of confidence. Each basis map represents a poro-fluid type with unique T1-T2 response. These responses may then be interpreted into fluid types. The weight for each basis map, at each depth, is a relative contribution normalized to the total porosity, i.e. it is a fractional porosity carried by the given basis map. BSS analysis is based on a mathematical technique called non-negative matrix factorization, imposing that the sources, or basis maps, and the associated weights, are non-negative. This non-negativity constraint ensures that the basis maps are physically meaningful, and that only additive combinations of the sources are allowed.

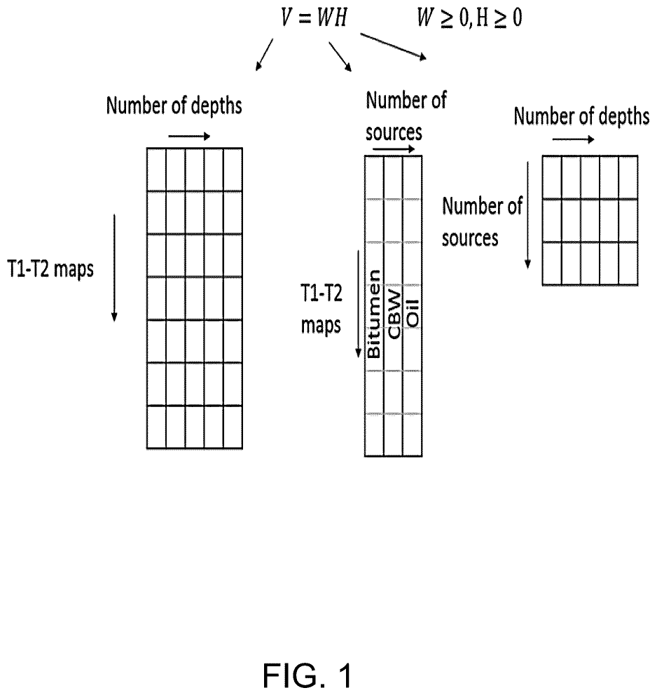

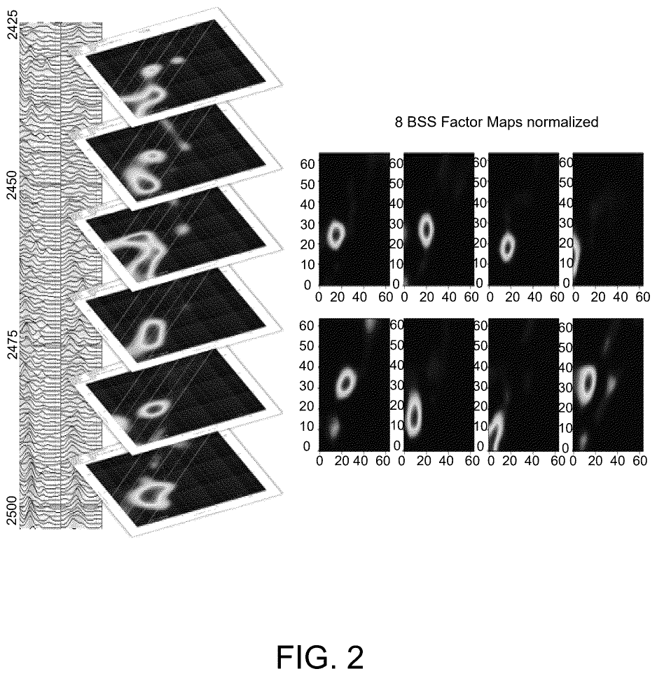

FIG. 1 shows the matrix factorization used in the BSS algorithm to estimate fluid signatures (W) and corresponding volume fractions (H) from the measurements (V). FIG. 2 shows an illustration of the BSS process. For this process, a stack of several original T1-T2 maps is shown at several depth points on the left. At the right side of FIG. 2, 8 BSS factors (basis-maps) have been extracted by a BSS algorithm. All original maps on the left can be computed by linear combination of BSS basis maps (on the right) and corresponding weights.

BSS gained success in fluid properties determination due to its advantages over depth-by-depth approach in using information from the third dimension, i.e. depth. BBS methods; however, have two well-known limitations. First, for the factorization step that produces basis maps (factors or sources), the method requires a user to specify the number of factors. Conventional analysis techniques use BSS in conjunction with analysis of variance, and the results have offered a procedure of gradual refining of the number of factors by increasing the share of variance explained by the factor analysis.

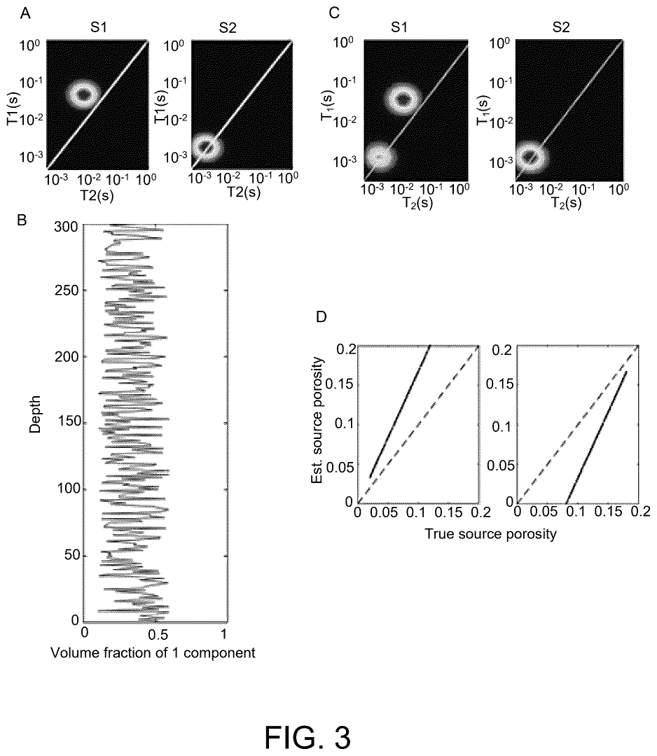

The second limitation of the BSS method is that the method may give inadequate fluid sources separation into individual basis-maps (factors or sources) when the fluid volume fraction dynamic range over zone of study is not large enough. Limitations also exist when fluid volume fractions do not reach close to 100 percent of the pore space. This is illustrated in FIG. 3, in which A (top left) shows two modelled and well-separated fluid sources, S1 and S2. Below, B (bottom left) shows volume fraction of S1 source in the simulated mixture of the two fluid sources. C (top right) demonstrates the results of BSS separation of two modelled sources from the mixture log. As may be observed, source S2 is well separated into its own basis-map, whereas the basis-map for source S1 contains a shadow of S2 sources. Poor sources separation leads to biases in the subsequent fluid volume calculation, illustrated in D (bottom right).

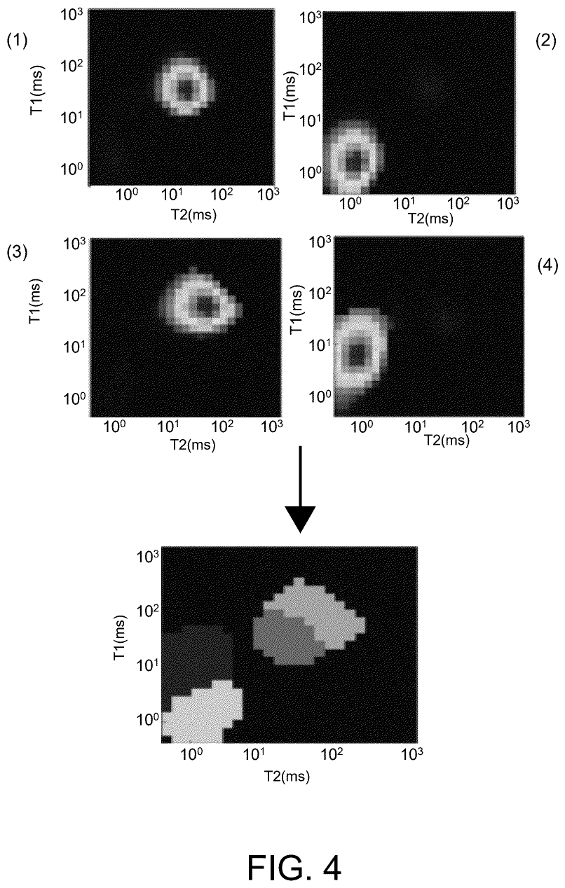

This and other shortcomings are overcome by introducing post-BSS clustering based on voting algorithm in conjunction with the technique to determine a maximum likelihood number of clusters. FIG. 4 shows four basis-maps (top portion above the arrow) after BSS factorization of a synthetic dataset. Each basis-map features the main cluster, which is a true fluid source, and one or two low amplitude shadow clusters. A voting algorithm samples every pixel on each of four basis-maps (factors) at once and assigns that pixel to one of four clusters corresponding to the basis-map with the maximum amplitude at that pixel (below arrow, cluster ID shown in color). These clusters are then used for fluid summation and interpretation in similar manner as in depth-by-depth analysis of maps by static cutoff lines segmentation of maps approach discussed.

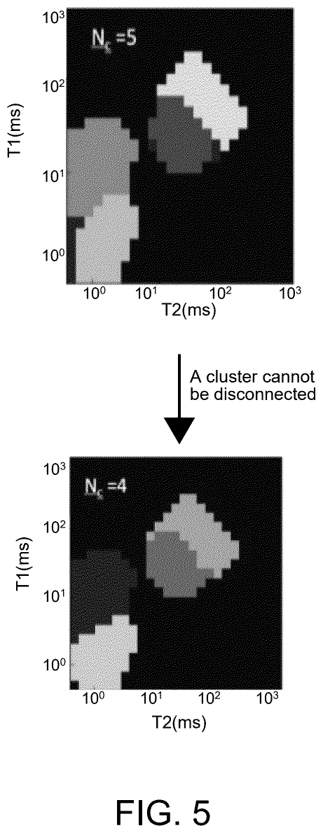

When the resolution of the features in BSS basis-maps increases, due to higher definition of the original T1-T2 maps and/or due to a larger number of factors in BSS factorization, the reassignment of pixels by the voting algorithm may result in complex topology of the final clusters. FIG. 5 illustrates a case of 5 factor-maps that produces 5 clusters, with one of them being discontinuous (brown color), which is nonsensical from a physical point of view. To alleviate this problem, several parameters are proposed to condition the clustering process.

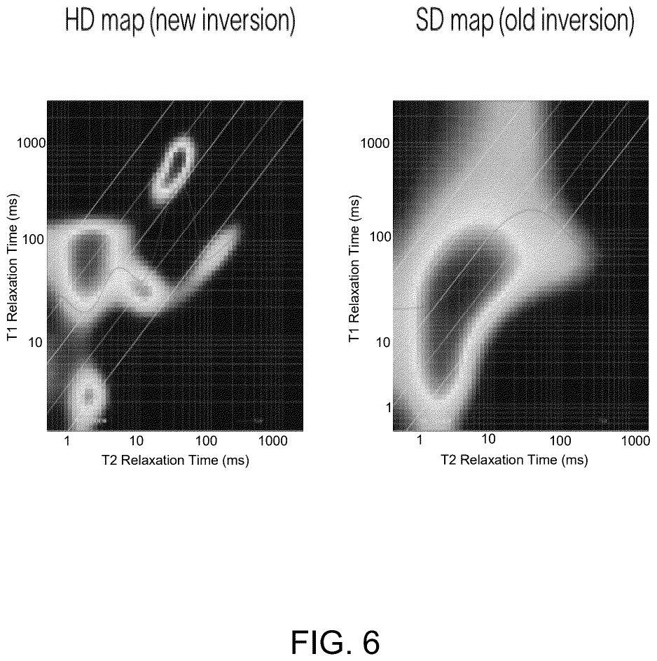

This method gains success with the results of previous standard definition (SD) T1-T2 inversion. While powerful, this technique requires the adjustment of many parameters of the algorithm. Such adjustment is daunting, particularly with the recent introduction of high definition (HD) T1-T2 maps. With SD maps, proposed clustering methods have demonstrated the capability to segregate fluid sources while overcoming the spreading and overlapping of T1-T2 fluid characteristic shapes that become clearly visible on individual maps (see FIG. 6). Conventional clustering methods may not separate fluid sources consistently because of complex topology of the intermediate BSS basis-maps. Adjusting parameters of these methods to induce shape picking is daunting and practically impossible.

T1 and T2 coordinates are displayed in the left panel of FIG. 6 that shows an HD map of NMR porosity over a 64 by 64 grid. The blue color signifies zero porosity density; other colors through green, yellow, and red signify increasing density porosity, and dark brown color denotes the maximum porosity density. The objective is to segregate all groups of closely spaced points (pixels) on the image with elevated porosity density into separate clusters.

Embodiments of the present disclosure are directed towards methods for clustering NMR 2D maps for evaluating formation.

In one or more embodiments, a method for clustering NMR 2D maps for evaluating the formation may be a water level separation (WLS) method. This method may utilize an algorithm for subdividing each of BSS factors (basis-maps) into a set of single-cluster sub-factors (WLS basis-maps). WLS basis-maps (WLS sources) and corresponding weights may be used to compute pore volumes corresponding to each WLS source. The algorithm does not require any parameter to control the algorithm's operation and is fast and reliable. In general, the algorithm may work on SD and HD BSS basis-maps, as well as on individual T1-T2 maps in depth-by-depth analysis.

In one or more embodiments, the method may be implemented using example two dimensional (2D) T1-T2 maps. The algorithm utilized in the method is generic and may be used on any N-dimensional data following the exact same steps, where the original coordinates correspondingly are N-dimensional.

In one or more embodiments, the algorithm of the method works on any grid size of any shape and with any natural number valued map at each grid-node. One example embodiment works as follows:
1. Loading a map as 2D array (matrix) of shape [m,n]. This array may be denoted as MAP. Values in MAP may be indexed by specifying their coordinates along T1 and T2 axes, each of which is an array of integers [0, . . . , m−1] and [0, . . . , n−1].
2. Raveling the MAP array into 1D array of shape [mn, 1] column-wise or row-wise, while noting the original 2D coordinates in a separate array of shape [mn, 2]. The raveled 1D array of values may be denoted as M, and its original coordinates may be denoted as array M-arg.
3. Sorting the array M by values from highest to lowest; the newly-sorted array may be denoted as MS. Any sorting algorithm may be employed.
4. Sorting array M_arg by the same sorting order as M→MS; the new coordinate array is defined as MS_arg. Both arrays MS and MS_arg refer to each point in array MS to its corresponding original coordinates in 2D of the MAP array.
5. The first value of the MS array is the value at the summit of the “tallest” island (cluster) on the original 2D map.
6. The first value of MS_arg array defines the position of that summit in the original 2D map. This coordinate point (first value in MS_arg array-2 values, corresponding to indices along T1 and T2 axis of MAP) may be assigned to cluster number 1. This pair-values point may be appended to an empty Summit array.
7. The method may continue by iterating, in a loop, through all remaining pair-values in MS_arg array. Iteration may be stopped at any index of MS_corresponding to a threshold value of MS array defined by a user, or it may go through all points:
a. Taking the next point-candidate (pair-values coordinates) from MS_arg array;
b. Calculating Euclidean distance between a new 2-value coordinate point (candidate) to all coordinate points in a summit array (summits);
c. If all distances calculated in step (b) are greater than the square root of 2 (or square root of N in case of N-dimensional data), then this candidate is not adjacent to any previously identified island-summits (cluster centroids). The candidate point may be appended to the summit array.
d. Alternatively, if the candidate point is adjacent to one of the previously defined island-summits in summit array, it may be skipped and proceed to the next point in MS_arg.
8. After the iteration is complete, the length of summit array, L (number of summits corresponding to number of identified clusters) is inferred. For example, if the summit array has five entries, then there are five summits of isolated islands, hence there are five clusters in MAP.
9. Allocating empty arrays for each cluster identified, e.g. Cluster_ID, where ID is an integer spanning 0 to L-1.
10. Populating every Cluster_ID array with a single point-coordinate of cluster summit from summit array.
11. Iterating in a new loop through all points (pair-values) in MS_arg array, starting from the first value, e.g. indexed 0. Iteration may be stopped at any index of MS_arg corresponding to a threshold value of MS array defined by a user, or it may also go through the points below:
a. Taking the next in sequence point-candidate (pair-values coordinate) from MS_arg array.
b. Calculating Euclidean distance(s) between a candidate point to all coordinate points in all Cluster_ID arrays.
c. Evaluating the values calculated wherein at least one distance calculated in step (b) must be less or equal than the square root of 2 (or square root of N in case of N-dimensional data)—this candidate point is adjacent (or matches) one of the points in one of the Cluster_ID arrays. For example, let the condition of adjacency is met for Cluster_IDx array. The point coordinates may be appended to the Cluster_IDx array.

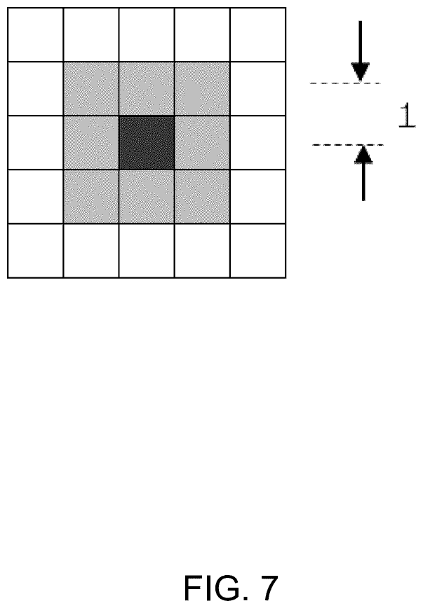

At this stage, all points of the original MAP array have been assigned to one of the identified clusters, as seen in FIG. 7.

In one or more embodiments, a method for clustering NMR 2D maps for evaluating formation may be a fluid interpretation mask (FIM) method. T2 measurements may not be sufficient for fluid characterization in shales due to overlapping response of different fluids; T2 measurement is primarily sensitive to the pore size. Laboratory measurements on shale samples; however, show that the variations in the T1/T2 ratio may be attributed to different fluid types including bitumen, clay-bound water, interparticle water, interparticle oil, and oil in organic matter pores. Consistent with laboratory measurements, log studies have shown that T1-T2 constraints respond to changes in the organic content. These results prove that it may be possible to use the T1-T2 response of fluids in shales for fluid identification and volumes estimation.

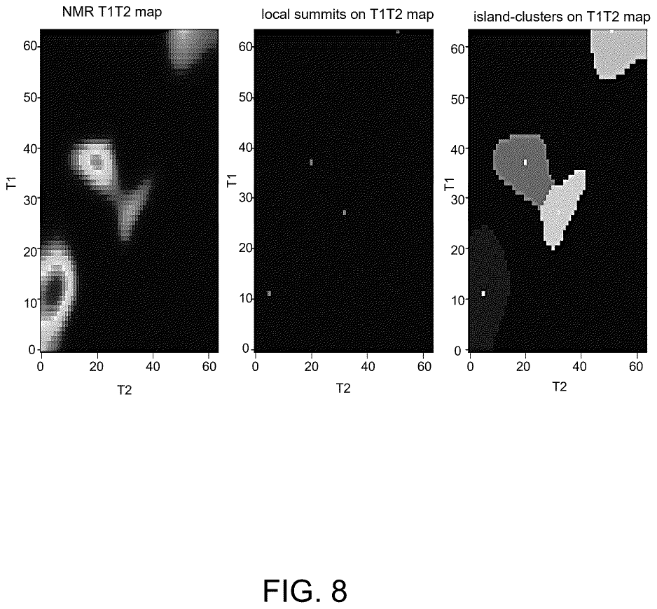

A T1-T2 map (MAP array) with porosity distribution that clusters in several groups is provided in FIG. 8. Each cluster covers a segment area on a T1-T2 map. A cluster associated porosity may be calculated by summing MAP values (porosity distribution) in all cells under segment area. As illustrated in FIG. 8, clusters may have a convex shape.

With this shape, summits approximate their centroids which corresponds to the centers of mass of the clusters. As will be understood, a cluster's summit may be used to represent the entire cluster “on average” for fluid typing.

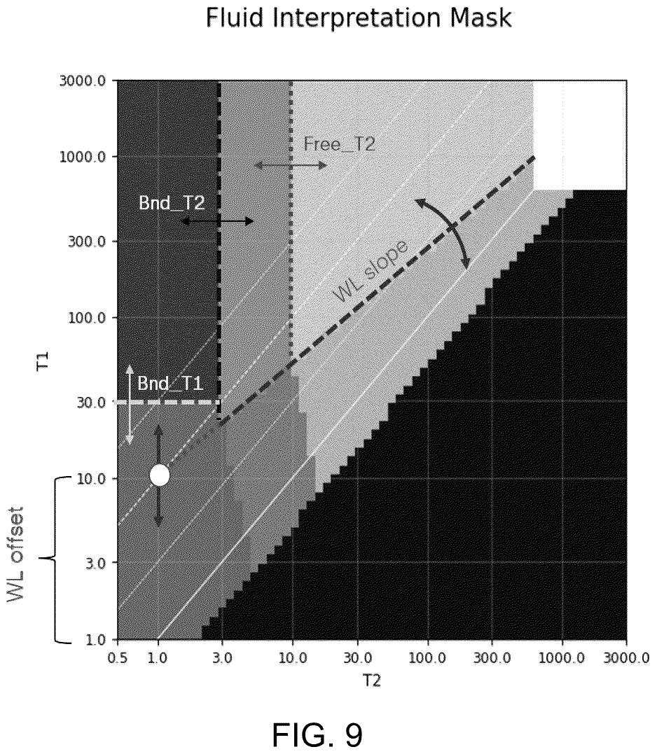

The FIM may be a T1-T2 grid, essentially a 2D array, segmented into various zones, each governed by distinct parameters. The classification of the fluid type for a given cluster is determined by the location of its peak point within the FIM framework. The algorithm utilized in the method may work as follows:
1. Creating an empty 2D array (grid) of the same size and shape as T1-T2 maps to be analyzed.
   a. Consider the example shown in FIG. 9, the grid is 64×64 along T1 and T2 axes, indices spanning 0-63 on each axis. For interpretation convenience, the axes' ticks and labels on the graphical plot of FIM are remapped to logarithmic scale-typical for T1-T2 maps.
2. Initializing FIM for the entire well (groups of wells)-including splitting the area of the FIM grid into several adjacent segments. The splitting may be performed by straight or curved lines. In embodiments, segments may cover the entire area of all valid points on T1-T2 maps that would be analyzed by FIM.
3. Populating each grid point of the FIM array with a distinctive fluid type code. (Number of segments and fluid type for each segment to be defined by an expert justified by theoretical or experimental data.)
   a. Consider the example shown in FIG. 9: Colors on FIM grid define fluid type: blue (code 0)—nonphysical area; grey (code 1)—clay bound water, green (2)—bound hydrocarbon (bitumen), light blue (3)—small pores water, cyan (4)—big pores water, light green (5)—small pores oil (oil in organic matter pores), orange (6)—big pores oil (oil in interparticle pores), white (7)—artifact.
4. Assigning a fluid type of a cluster by calling the FIM array with indices of cluster's summit along T1 and T2 axes. For example, if cluster-A summit has indices [T1=12, T2=10], then cluster-A fluid type is defined by sampling the FIM array with indices, e.g. FIM [12,10] which would render value 1. This code indicates “clay bound water” and is represented by grey color segment in FIG. 9.
5. Several clusters (cluster summits) may fall onto the same segment of FIM, and hence assigned to the same fluid type. Such cluster volumes may be summed together to form a total volume of that fluid type.
6. Interpretation of the fluid types and volumes, and derivatives of fluid types and volumes (e.g. producibility index, permeability, etc.) may be performed iteratively, by changing FIM segmentation by specifying different values of segment lines parameters, and re-running fluid interpretation and fluid summation.

In one or more embodiments, a two way interpretation workflow may be carried out using both WLS and FIM. This may be done by 1) direct interpretation of individual T1-T2 maps in depth-by-depth mode; and 2) interpretation of individual fluid sources as WLS clusters split from BSS factors (basis-maps).

In one or more embodiments, the a two way interpretation workflow may be carried out by depth-by-depth interpretation of individual maps include:
1. Initializing FIM for the interval of analyses by specifying FIM segmentation parameters.
2. Iterating all T1-T2 maps along depth of the interval of analyses:
a. Taking a MAP.
b. Performing WLS clusterization of the MAP: identify number of clusters, determine segments (patches) of each cluster, determine indices of clusters' summits.
c. Iterating all clusters within the MAP:
   i. Determining a fluid type using FIM and indices of the cluster's summit.
   ii. Calculating a cluster's porosity by summing values of MAP under segment (patch) of the cluster.
   iii. Adding a cluster's porosity volume to appropriate Fluid Type Volume array according to the fluid type of the cluster from FIM.

Interpretation may be iterated with another set of FIM segmentation parameters, if required.

In one or more embodiments, interpretation of fluid sources may be interval based, including:
1. Defining a zone of interest using any conventional method.
2. Initializing FIM for the interval of analyses by specifying FIM segmentation parameters.
3. Loading array of T1-T2 maps from the zone of interest.
4. Performing BSS factorization of T1-T2 maps over the zone of interest:
   a. Setting a number of factors N for BSS factorization. N may be determined algorithmically or specified by a user.
   b. Performing a BSS factorization. Store N BSS basis-maps (2D factors of same shape as T1-T2 maps) and N weights (1D arrays of zone length).
   c. Iterating through all BSS basis-maps (factors):
      i. Take a BSS basis-map.
      ii. Performing WLS clusterization of BSS basis-map. Save WLS clusters as new WLS basis-maps.
      iii. Copying the weight of selected BSS basis-map to all new WLS basis-maps derived from the BSS basis-map.
5. Iterating all clusters within MAP:
   a. Taking a WLS cluster basis-map.
   b. Computing porosity channels for WLS clusters over zone of interest by calculating porosity under WLS cluster basis-map and then multiplying that porosity by WLS cluster weight.
   c. Interpreting WLS cluster fluid types by sampling FIM with WLS cluster summit indices.
   d. Adding cluster's porosity volume to appropriate Fluid Type Volume array according to the fluid type of the WLS cluster.

In embodiments, interpretation may be iterated with another set of FIM segmentation parameters.

Aspects of the present disclosure reverts analysis to automatic analysis. In embodiments, an estimation of factors in NMR two-dimensional maps factorization is performed using regression analysis of residual misfits. The automation is based on the idea of separation factors corresponding to the signal from the factors corresponding to noise. As a result, the number of method parameters is drastically reduced. Practically, the method is fully automatic and can self-diagnose its own failure. Furthermore, a user can refine automatic results with further factorization

### Initial Matrix Factorization and Misfits Computation

Aspects of the disclosure start with BSS. In this method, the T1-T2 maps corresponding to the entire log are placed in a data matrix denoted as V. Each column of matrix V contains one T1-T2 map, arranged as a vector at a given depth. This matrix is factorized into two matrices, W_{N} and H_{N}. Matrix W_{N} contains the T1-T2 signatures of the distinct fluids present in the log in each column and matrix H_{N} contains the corresponding volume fractions of the different components at each depth. N denotes the number of factors, that is, expected fluids. Mathematically, V is approximated with V_{N}.

$$V \approx {V}_{N} = {W}_{N} {H}_{N} \qquad Equation ( 1 )$$

BSS is also known as a non-negative factorization technique in a manner shown. Other factorization techniques, e.g., principal component analysis, can be used. Factorization is performed for N=3,4, . . . . Nₘₐₓ. Minimum number of factors is chosen as 3 because typically it is expected that at least 3 types of fluid signatures are present in the analyses (clay bound water, free water, and hydrocarbons). The number Nₘₐₓ is chosen approximately two times higher than the number of all expected fluid signatures. Factors with N in the range 0.5Nₘₐₓ to Nₘₐₓ correspond to noise. Aspects of the disclosure define that the value of N is 25.

There are several typical matters with respect to a data matrix V, that do affect the analyses. First, the matrix could be considered on a rock type basis. Namely, for each rock type, a separate V is built and only depths belonging to that rock type go into that data matrix V. Subsequently, each data matrix is analyzed independently. Rock types may be chosen with any classification method used in the industry. They are typically chosen based on geology. Second, the T1-T2 dimensionality of V can be decreased, because certain T1-T2 pairs do not correspond to any fluid expected to be observed. That can happen because such fluids do not exist, or the NMR tool is not sensitive to them. Thus, certain T1-T2 points are eliminated from the analyses. Such elimination can be done either pre-acquisition of V based on tool properties or at post-data acquisition based on average bin porosity of T1-T2 points. All procedures are performed in the same way for data matrices built on a rock type basis with possibly excluded T1-T2 points.

After BSS, misfit characteristics of the factorization are computed. One of them is a relative residual “unexplained” variance

$${U}_{N} = \frac{Var ( V - {V}_{N} )}{Var V} \qquad Equation ( 2 )$$

where variance Var is taken through all T1-T2 and all depth indices. This misfit characteristic corresponds to the classical relative “explained variance” VarV_{N}/Var V. Namely, for principal component analysis U_{N}=1−(VarV_{N}/VarV). With BSS this relationship is not exact, but only approximate; however, U_{N} keeps the character of the function decreasing with N, with its decrement representing contribution of each consecutive factor.

In embodiments, misfit characteristics can also be computed for each depth d. In one embodiment, it is proposed to use characteristics based on a relative misfit norm.

$${R}_{N} ( d ) = \frac{{{L}^{2} ( V - {V}_{N} )}^{d}}{{L}^{2} {V}^{d}} \qquad Equation ( 3 )$$

In this formula super-script d indicates a depth index of the corresponding matrix and L² is a Euclidean norm of a vector. For example, consider a data matrix A^{td}, having a depth index d and index t, corresponding to T1-T2 relaxation times. Then the Euclidean norm at a certain depth d is defined as

$${L}^{2} {A}^{d} = \sqrt{{\sum }_{∀ t} {( {A}^{td} )}^{2}} . \qquad Equation ( 4 )$$

To get a single characteristic out of R_{N}(d) for the entire depth interval embodiments use percentiles.

$${R}_{N}^{p} = percentile ( {R}_{N} ( d ) , p ) \qquad Equation ( 5 )$$

Median

$${R}_{N}^{50}$$

and 90th percentile

$${R}_{N}^{90}$$

values are used. These misfit characteristics, especially the 90th percentile, emphasize the transition from signal bearing factors to ones corresponding to noise.

Any other misfit characteristics can be computed and used for the purposes of determining a proper number of factors. Norms other than Euclidean can be used in Equation 3. Additionally relative total porosity misfit can be used.

$${ϕ}_{N} ( d ) = \frac{\vert {\sum }_{∀ t} {( V - {V}_{N} )}^{t d} \vert}{\vert {\sum }_{∀ t} {V}^{td} \vert} , {ϕ}_{N}^{p} = percentile ( {ϕ}_{N} ( d ) , p ) \qquad Equation ( 6 )$$

All these misfit characteristics can be used in place and in addition to

$${R}_{N}^{90} , {R}_{N}^{50} ,$$

and U_{N}. Concentration is described below on these three values. They are sufficient to determine proper numbers of factors and ensure quality control of such determination.
Initial Separation of Signal Bearing Factors from Ones Corresponding to Noise

In the analysis, it is assumed that in factorization only a certain number of factors (less than Nₘₐₓ) correspond to useful signals while other factors correspond to measurement noise. Using a principal component analysis explained variance approach, a relative residual variance U_{N} as well as other misfits around N corresponding to noise, will be approximately linear functions with sequential decrements being approximately equal since noise is uniform across T1-T2. Around lesser N values, that correspond to the useful signal decrements, it is anticipated that these values are higher and a misfit characteristic graph “picks up”.

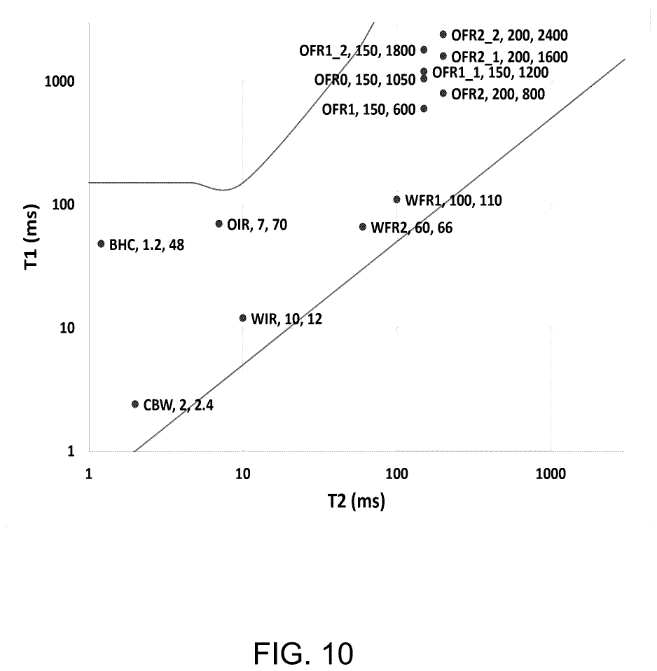

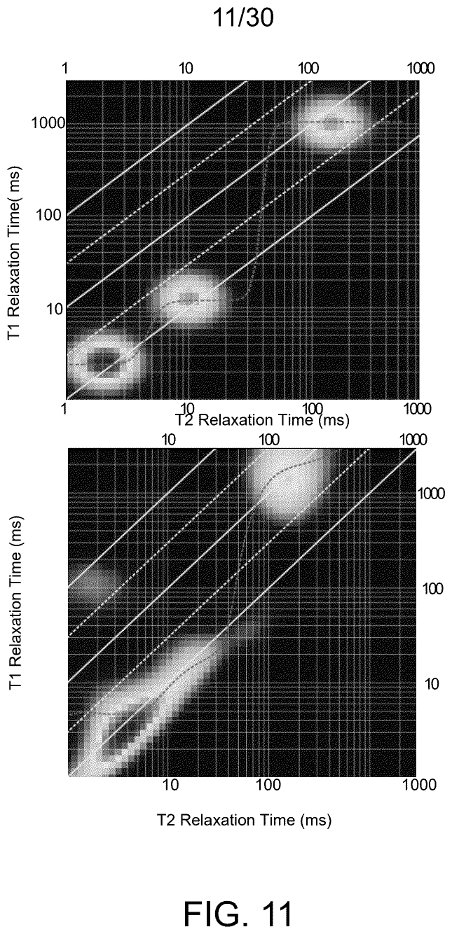

A synthetic dataset containing 13 different fluids with centers of their signatures are illustrated in FIG. 10. These fluid signatures are Gaussians of the same width (see top of FIG. 11). In this embodiment, an entire dataset is built to contain 2561 depth points. Each point contains up to 4 fluids of the 13 different fluids described. Total porosity of 20p.u. is distributed between these fluids at each depth with these distributions varying to achieve reasonable contrast. After model maps are constructed, model echo trains are built with a 6 wait-time CMR NG long sequence, adding a Gaussian noise of 2p.u. per echo, and high-definition inversion is performed.

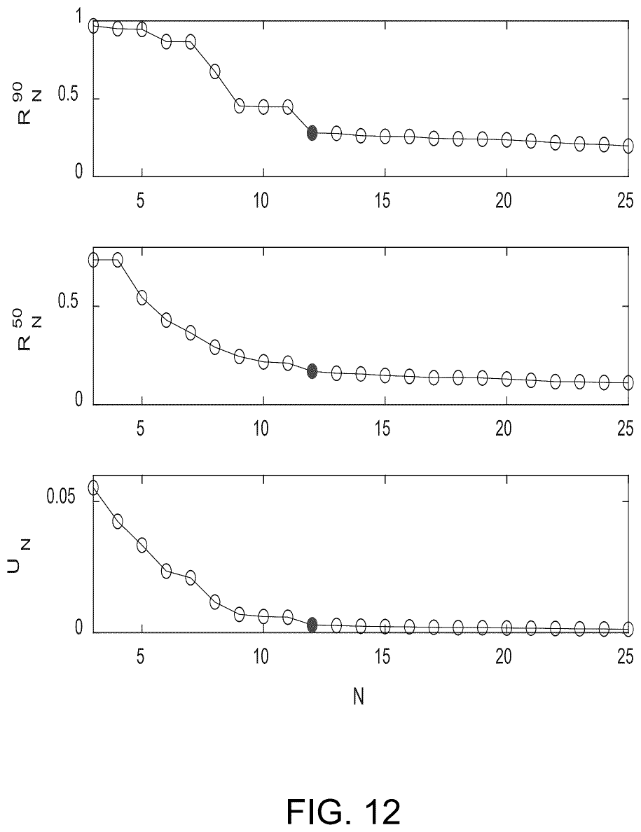

All 2561 inverted T1-T2 maps that comprise data matrix V undergo BSS with a number of factors from 3 to 25. Misfits defined according to Equations 3 and 5 are computed and demonstrated in FIG. 12.

It is expected to observe 12 factors since fluid signatures for OFR0 and OFR1_1 have centers that are too close to be distinguished. As illustrated, the graphs demonstrate linear behavior of misfits for N≥12 with low slope with a “picking up” at values of N<12. Note that the misfits based on the relative norm of the quantile emphasize the transition from signal to noise. This is especially true for

$${R}_{N}^{90} .$$

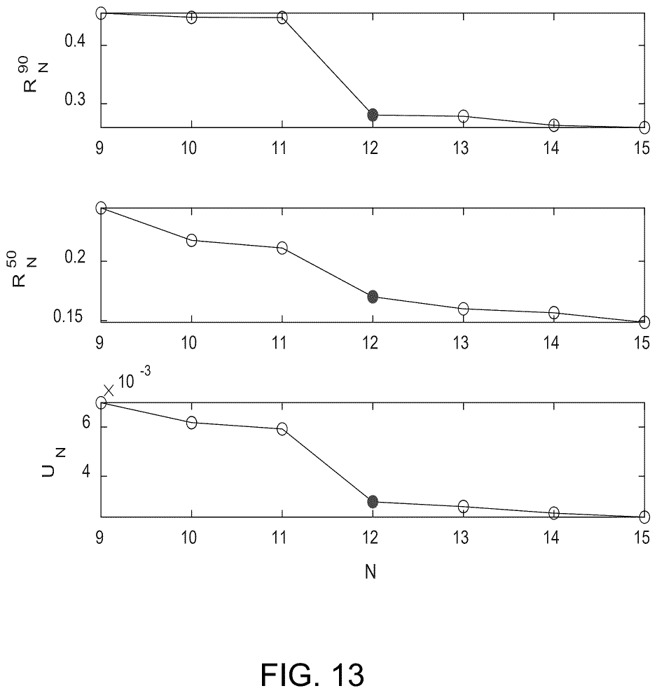

FIG. 13 illustrates an expanded view of the transition zone specifically illustrating the change occurring in the “picking up” section.

To determine the “picking up” section for a misfit [symbol] _{N}

$$( {R}_{N}^{90} , {R}_{N}^{50} ,$$

or any other), the decrement of this misfit Δ [symbol] _{N}= [symbol] _{N}− [symbol] _{N+1} is analyzed. Since the number Nₘₐₓ is chosen to ensure sufficient representation of the factors after transition from signal to noise, the median of the entire decrement med (Δ [symbol] _{N}) is close to the median of the decrement after transition. This is demonstrated in the FIGS.

The value-med (Δ [symbol] _{N}) is chosen as the slope of the cutoff line and another median med ( [symbol] _{N}+N med(Δ [symbol] _{N})) as its intercept. The value of the cutoff line to determine proper number of factors for the misfit [symbol] _{N} is provided in equation 7.

$$Λ ( N ) = m ed ( {ℳ}_{N} + N med ( {Δℳ}_{N} ) ) - N med ( {Δℳ}_{N} ) \qquad Equation ( 7 )$$

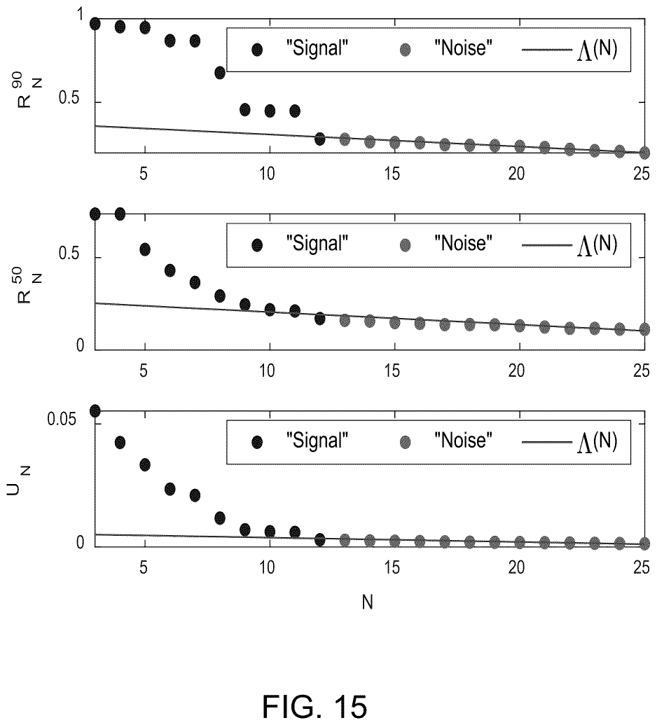

The first N=N* for which [symbol] _{N}<Λ(N) is the end of the “signal” factors, “noise” factors start with N*+1. FIG. 15 illustrates this estimation for the synthetic data and demonstrates that N*=12 is determined for all misfits

$${R}_{N}^{90} , {R}_{N}^{50} ,$$

### and U_{N}.

Estimation of the Number of Factors Recommendation with Linear Regression

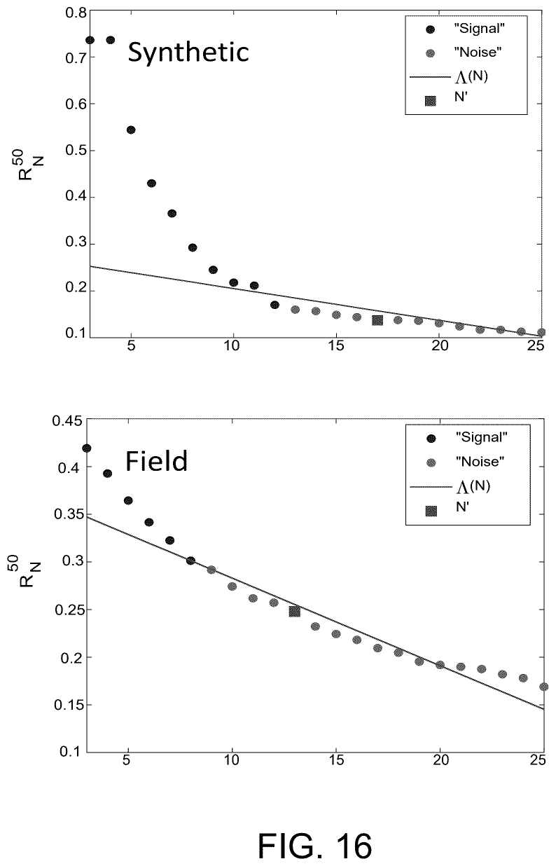

FIG. 15 shows that the cutoff line-based determination is acceptable for synthetic data. FIG. 16 demonstrates the analysis of field data.

It should be noted that the nature of “noise” in the synthetic data is straightforward and defined by the model. There is a Gaussian noise added to the synthetic echo trains that is conveyed through inversion and BSS. The nature of “noise” in field data is more complex. In embodiments, the noise can include tool noise as well as signal from certain fluids that are randomly distributed with respect to depth.

It is beneficial to have certain confidence intervals both for internal quality control and for the case when factors computed on certain data are used for analyses with different data.

The method described herein uses preliminary determinations based on [symbol] _{N}≤Λ(N) cutoffs for further refinement with linear regression. First, the method identifies or determines when the value N′(start of the misfits) goes into regression. This should be a value that is well into the “noise” factors but that is still low enough to ensure proper number of samples for a regression. This value is defined as a middle of largest consecutive interval, where misfits are not above the cutoff (i.e., [symbol] _{N}≤Λ(N). The green box in FIG. 16, depicts these points. Next, misfit values [symbol] _{N}, N=N′, . . . . Nₘₐₓ are taken and then linear regressions, together with confidence intervals, are computed for these points. Linear regression and confidence intervals are determined using a classical maximum likelihood approach with model based on the normal distribution. Namely, the regression line M(N) is defined as follows:

$$M ( N ) = {M}_{0} + μ N \qquad Equation ( 8 )$$

$$μ = \frac{1}{{SS}_{N N}} {\sum }_{N = {N}^{′}}^{{N}_{max}} ( {ℳ}_{N} - 〈 {ℳ}_{N} 〉 ) ( N - 〈 N 〉 )$$

$${M}_{0} = 〈 {ℳ}_{N} 〉 - μ 〈 N 〉$$

$${SS}_{N N} = {\sum }_{N = {N}^{′}}^{{N}_{max}} {( N - 〈 N 〉 )}^{2}$$

$$( {ℳ}_{N} 〉 = \frac{1}{{N}_{c}} {\sum }_{N = {N}^{′}}^{{N}_{max}} {ℳ}_{N}$$

$$〈 N 〉 = \frac{1}{{N}_{c}} {\sum }_{N = {N}^{′}}^{{N}_{max}} N$$

$${N}_{c} = {N}_{max} - {N}^{′} + 1.$$

The upper M⁺(N) and lower M⁻(N) boundaries for the regression confidence interval with the n_{σ} (number of sigma-confidence) are:

$${M}^{+} ( N ) = M ( N ) + {t}_{inv} ( 1 - α , {N}_{c} - 2 ) S ( M \vert N ) \qquad Equations ( 9 )$$

$${M}^{-} ( N ) = M ( N ) - {t}_{inv} ( 1 - α , {N}_{c} - 2 ) S ( M \vert N )$$

$$S ( M \vert N ) = {SE}_{ℳ} = \sqrt{( 1 + \frac{1}{{N}_{c}} ) + \frac{1}{{SS}_{NN}} {( N - 〈 N 〉 )}^{2}}$$

$${SE}_{ℳ} = \sqrt{\frac{1}{{N}_{{c}^{- 2}}} {\sum }_{N = {N}^{′}}^{{N}_{max}} {( {ℳ}_{N} - M ( N ) )}^{2}}$$

$$α = Φ ( {n}_{σ} ) - Φ ( - {n}_{σ} ) .$$

Here the value tᵢₙᵥ(β, k) is the two-tailed inverse of a Student's t-distribution for the probability β and k degrees of freedom. Φ (x) is defined as the cumulative distribution function of the unit normal distribution (i.e., the normal distribution with the mean of 0 and the standard deviation of 1). In the aspects described a “number of sigma” approach is used and a confidence level a is specified as a function of the number of sigma no.

Using linear regression upper confidence interval boundary, the first N=NT for which [symbol] _{N}≤M⁺(N) as the end of the “signal” factors is defined. “Noise” factors start with the values N^{r}+1. N^{r} and are the values recommended for the number of factors. As will be understood, there may be cases where some random spurious non-sequential dipping points [symbol] _{N}≤M⁺(N), i.e., both [symbol] _{N-1}>M⁺(N−1) and [symbol] _{N+1}>M⁺(N+1) are present. Such spurious points are filtered out from consideration.

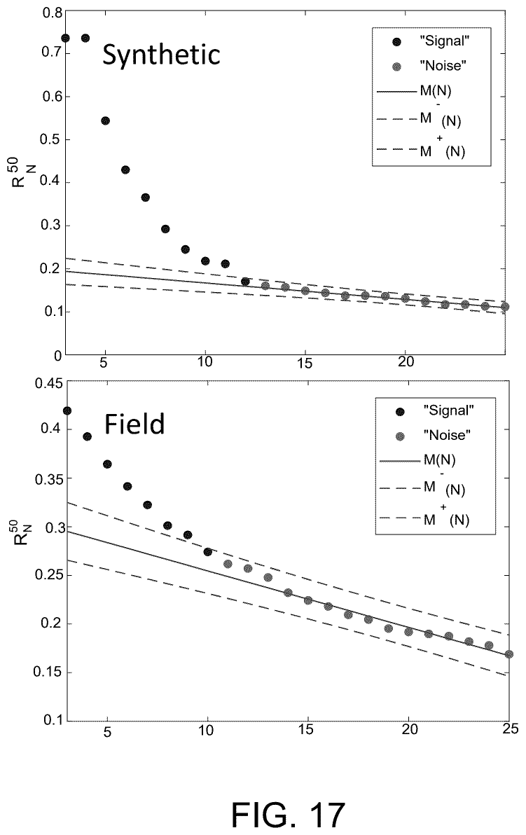

FIG. 17 demonstrates regression-based determinations of the number of factors for the synthetic and field data used to build FIG. 16. The confidence level used is 3-sigma. N^{r}=12 for the synthetic data, which is the proper number of factors.

The recommended number of factors N^{r} is determined independently for each type of misfit, namely, to

$${R}_{N}^{90} , {R}_{N}^{50} ,$$

U_{N} and any other mentioned above. These determinations should be unified either by taking a median value of individual numbers, or by taking a maximum of the individual numbers; the latter being the more conservative approach. Investigations with synthetic data have shown that using the median and 3-sigma gives results that coincides the number of the distinguishable fluids in the model. Thus, in embodiments, the median is used as the individual recommended number of factors determined for each type of misfit with 3-sigma confidence intervals. Results have been observed that are consistent with expectations for n_{σ} in the interval from 2 to 3.

### Refinement of the Factors to Characterize Individual Fluids and Post-Refinement Estimation of N^{r}

BSS derived factors often cannot be used per se. When fluid volume fraction dynamic range is not large enough, BSS derived factors may become multi-modal and possess “ghost” fluid signatures. In this case using BSS derived factors for interpretation delivers misleading results. BSS factors; therefore, should be refined into the composition of mono-modal maps corresponding to individual fluids. This decomposition can be performed in multiple ways with some of them described below. The precise way of decomposition is irrelevant for analyses. The relevant fact is that BSS factors W_{N} are approximated as linear combinations of the M_{N}≥N individual basis non-negative fluid signatures maps \tilde{W}_{M}_{_{N}}≥0.

$${W}_{N} \approx {\tilde{W}}_{{M}_{N}} {\tilde{H}}_{{M}_{N}} \qquad Equation ( 10 )$$

Assuming the relationship M_{N}≥N because individual BSS factors W_{N} are linearly independent as a rule. Usually, non-negativity of projection coefficients \tilde{H}_{M}_{_{N}}≥0 is required as well.

Equation 10 can be derived in multiple ways:
Clustering results are applied to each of W_{N} maps so that all T1-T2 points belonging to a cluster keep value of a particular BSS factor map, while zero value is assigned to all points outside the cluster. Thus, the size of the new basis M_{N}=N² and \tilde{H}_{M}_{_{N}} correspond to the summation. Some of the resulting Ŵ_{N}_{²} may turn out to have very low values, so some of them may be eliminated based on the total porosity value threshold for individual maps of \tilde{W}_{N}_{²}. Upon elimination, corresponding projection coefficients Ĥ_{N}_{²} are omitted.
Simultaneous Gaussian fitting of all BSS maps can be performed.
Gaussian fitting of individual BSS maps may be performed sequentially. A method is applied to T1-T2 maps on depth-by-depth basis but can easily be applied to individual BSS maps. Post-fitting some of the resulting Gaussians may be eliminated based on the total porosity value threshold and some may be combined if their centers are close enough with proper correction of projection coefficients \tilde{H}_{M}_{_{N}}.

When the value of the individual fluids basis \tilde{W}_{M}_{_{N}} is determined with one of the methods described above or with any other method, \tilde{H}_{M}_{_{N}} can be determined with one of the projection methods used in linear algebra including ones producing non-negative \tilde{H}_{M}_{_{N}}≥0.

Once decomposition is established, refined data matrix approximation is defined as

$$V \approx {\tilde{V}}_{N} = {\tilde{W}}_{{M}_{N}} {\tilde{H}}_{{M}_{N}} {H}_{N} . \qquad Equation ( 11 )$$

Afterwards, refined misfit characteristics

$${\tilde{R}}_{N}^{90} , {\tilde{R}}_{N}^{50} ,$$

and Ũ_{N} are defined according to Equations 2-5 in which approximation V_{N} is substituted by refined approximation \tilde{V}_{N}. Any other refined misfits are defined using this substitution as well.

Subsequently, all steps of the number of factors determination described in the above sections are performed for refined misfits as well as for BSS misfits. The steps are cutoff line determination followed by linear regression. The determinations for individual BSS and refined misfits are then unified by using the median.

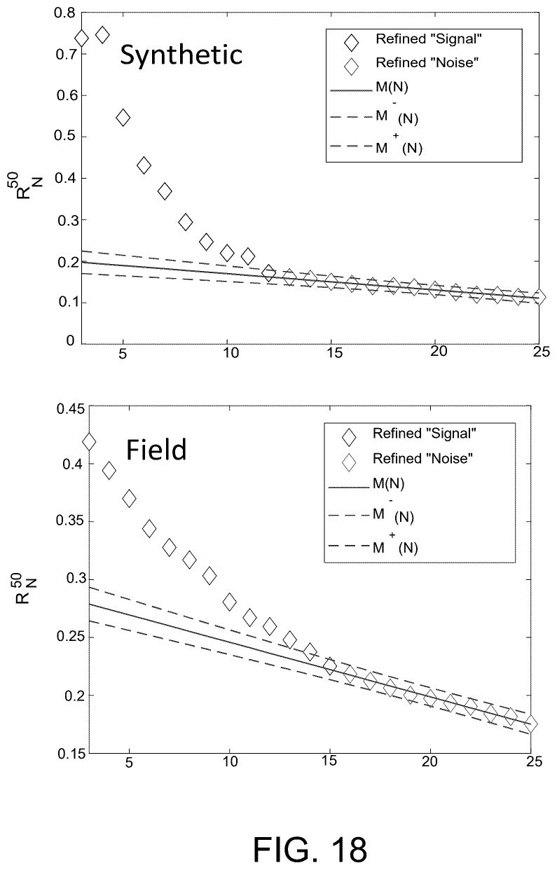

FIG. 18 demonstrates the estimation of the recommended number of factors for synthetic and field data used to build FIGS. 16 and 17. Refinement of factors is performed with sequential Gaussian fitting of individual BSS maps. In fitting individual fluid signatures, widths are sought to match the resolution of high-definition maps produced by the inversion.

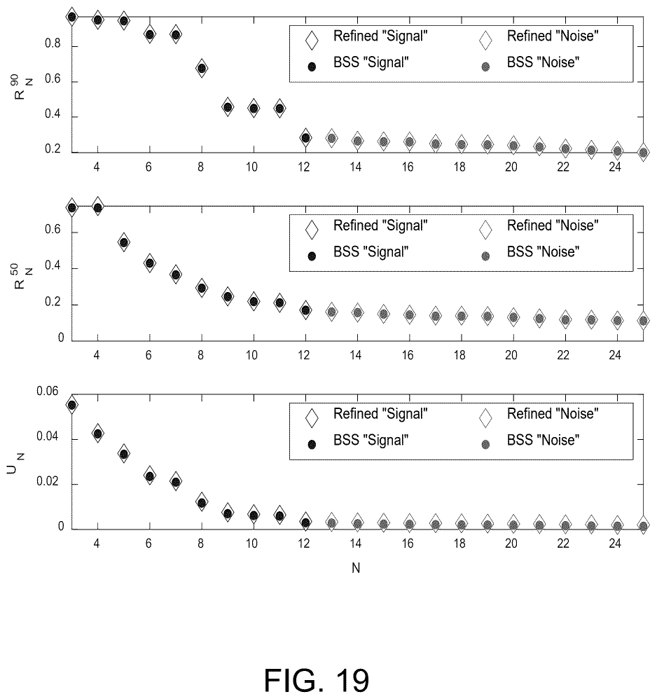

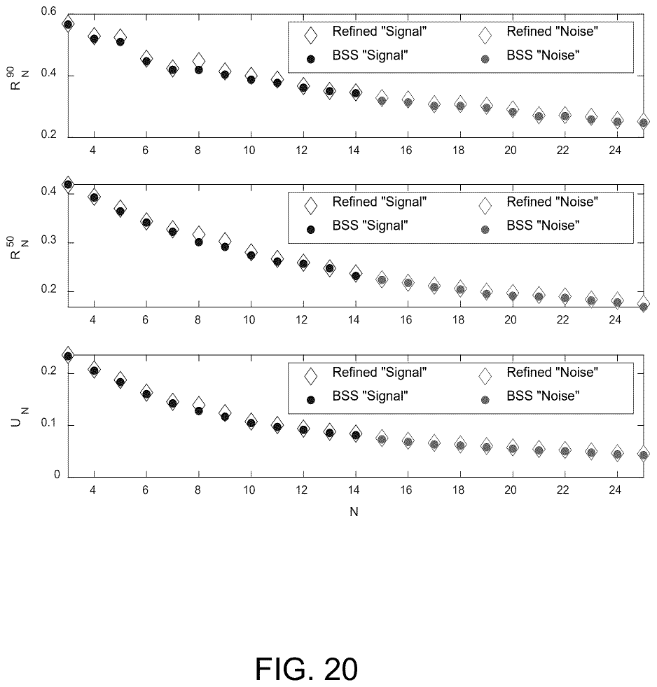

FIGS. 19 and 20 display all BSS and refined misfits for these synthetic and field data together. The misfit markers are split into “signal” and “noise” according to the overall recommended number of factors. FIG. 19 clearly demonstrates that BSS and refined misfits are practically indistinguishable for the synthetic data. FIG. 20 shows that the misfits are very close for the field data.

### Quality Control of the Number of Factors Estimation

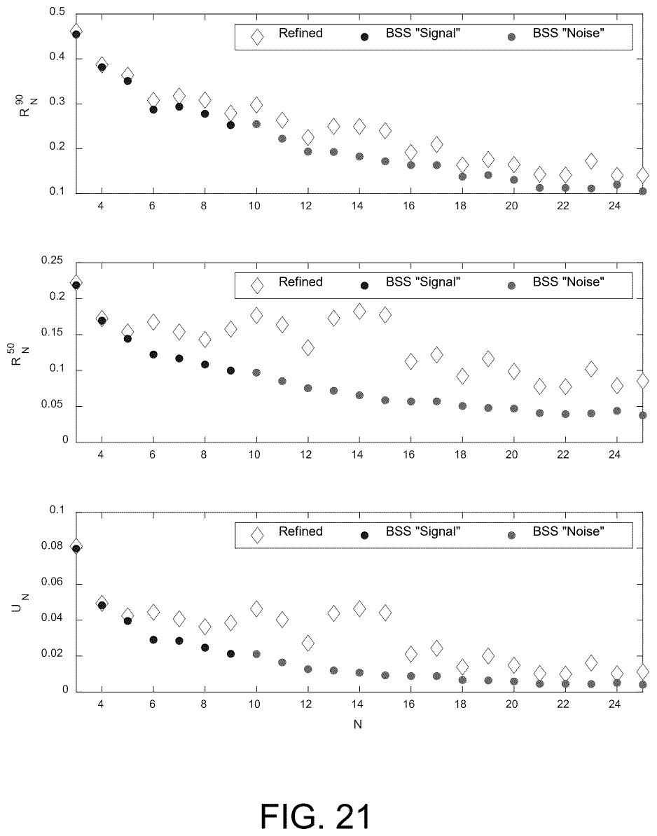

Aspects of the procedure contained herein have the capability to discover that the entire factorization procedure is not valid. BSS factorization is performed followed by a refinement procedure with sequential Gaussian fitting. While fitting individual fluid signatures, widths are sought to match the resolution of high-definition maps. The input maps in this data is standard resolution. In embodiments, it should be expected that refinement should not work. FIG. 21 clearly demonstrates that this is the case. Refined misfits reveal non-monotonous “jumping” behavior that should not be expected in factor analysis.

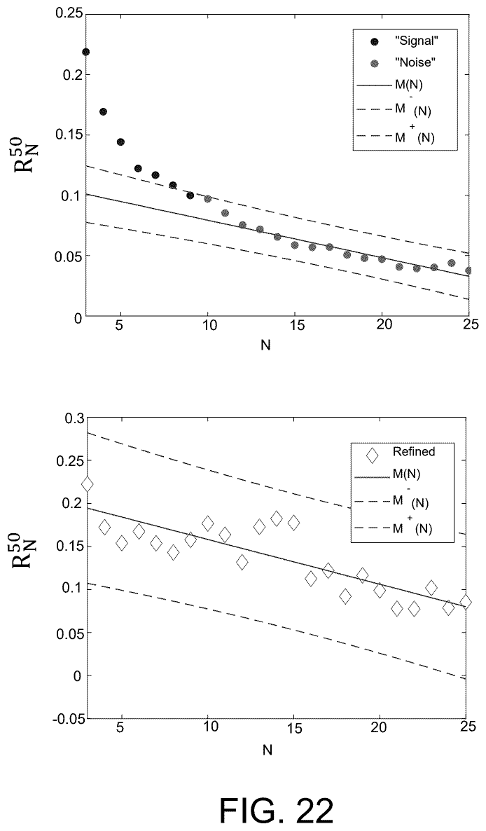

When these refined misfits are passed to the algorithm estimating N^{r}, all misfit points lie below an upper boundary of confidence interval. FIG. 22 reveals that behavior on the bottom graph; while on the top graph, the determination process shows an expected behavior for BSS misfits.

In a case when a share of misfits that are greater than the upper boundary of the confidence interval are less than a small reliability cutoff pᵣ value, the procedure fails, and factorization results are declared invalid.

$$\frac{card ( N \vert {ℳ}_{N} > {M}^{+} ( N ) )}{{N}_{max} - 3 + 1} < {p}_{r} \to Failure \qquad Equation ( 12 )$$

Investigations show that pᵣ=0.1 is a suitable practical value to distinguish all visibly observed failure cases.

It has been observed that if the procedure fails for one of misfit types, it fails for all others. The refinement process; therefore, is invalid if failure happens for one of misfits. Theoretically, the estimation can fail for original BSS factors. It can happen if all the data for all depths contain only noise.

### Choosing Parameters for the Number of Factors Estimation

Overall, the algorithm has the following adjustment parameters: maximum number of factors Nₘₐₓ; confidence interval width n_{σ}; and reliability cutoff pᵣ. Based on observations, it is recommended that the following values are used: 3 for n_{σ} and 0.1 for pᵣ. The value for Nₘₐₓ is 25. It is based on a-priori considerations (twice of the number of distinguishable fluids) as well as on observations with field data when increasing for Nₘₐₓ to 30 or 35 did not change the N^{r} outcome at all or changed it only by one step.

### Interpretation of the Factorization Results

Once a recommended number of factors NT is determined, the procedure of the separation of the T1-T2 map data is finished. Afterwards, following the equations recited above \tilde{W}_{M}_{_{Nr}} are individual fluids signatures and \tilde{H}_{M}_{_{Nr}}H_{N}_{^{r}} are fluid weights. Assignment of the fluids into the petrophysically meaningful categories such as clay bound water, free water, oil, etc., can be done with many methods known in the industry both manually and automatically.

### Applicability to Data Obtained by Other Inversions, Data Processing, Factorization, and Factorization Refinement Methods

The method described applies equally to data acquired by any NMR logging tool processed by any inversion with subsequent factorization and post-factorization refinement to obtain factors corresponding to individual fluids. Particularly, it applies equally, regardless of the dimensionality of the output. For instance, it applies to one dimensional T2, T1 or diffusion measurement and inversion schemes, to two dimensional T1 and diffusion (or T2 and diffusion) measurement and inversion schemes, and to three dimensional T1, T2, and diffusion measurement and inversion schemes. It also applies to other factorization methods; such as principal component analysis and various post-factorization refinement methods, as soon as the combined method delivers a series of approximations V_{N} of the original data V for a given number of factors or components N. It is these approximations that constitute a starting point for analyses.

### Application of Factors Determined on Certain Nmr 2d Maps for New Maps

In another non-limiting example embodiment of the present disclosure, aspects of the disclosure may be able to employ BSS factors and WLS clusters established on previously studied maps for new maps. Quality Control (QC) criteria is proposed for the results based on residual misfit analysis that is based on the idea of separation contribution of factors corresponding to the signal from the contribution corresponding to the noise. The method is automatic and can self-diagnose its own failure as well as deliver information for advancing analysis and results improvement. Thus, data for previously analyzed wells and related interpretation insights are utilized as completely as practically possible.

The procedure of the present disclosure is summarized in the following manner:
Certain dataset is chosen as a reference. As a rule, this dataset has an ample set of logs and possibly core in addition to NMR 2D maps. BSS with non-negative matrix factorization may be utilized. Residual misfits are calculated for each number of factors and analyzed. Recommended number of factors is determined and misfits' confidence intervals are calculated.
Non-negative weights for previously determined BSS factors (and feasibly WLS clusters) are determined with the misfit-minimization-based projection technique defined below. The method starts with the number of factors determined on the previous step. Residual misfits are calculated and compared with previously determined confidence intervals.
In case of success, if the newly determined misfits stay below upper levels of confidence, these new weights are used together with previously determined factors in the same way as in ab initio procedure. Particularly, fluid interpretation masks determined on the previously analyzed data, can be re-used.
In case of failure, if the newly determined misfits exceed upper levels of confidence, several ways of advancing analysis are possible. The first is increasing the number of factors (again previously determined factors are used) and comparing respective misfits with respective confidence intervals until success.
If success is not achieved per-depth misfit is calculated on new maps and compared with upper confidence to delineate outlier zones. These zones can be taken out of consideration and/or analyzed separately.
If success is not achieved and outlier zones cannot be separated from analysis, the procedure restarts with newly acquired data ab initio.
   Initial BSS and WLS with Number of Factors Determination for the Reference Dataset

The method starts with a matrix factorization technique (BSS) that is performed on the reference dataset as shown in FIG. 1. In this method, the T1-T2 maps corresponding to the entire log are placed in a data matrix denoted as V. Each column of matrix V contains one T1-T2 map, arranged as a vector at a given depth. This matrix is factorized into two matrices, W_{N} and H_{N}. Matrix W_{N} contains the T1-T2 signatures of the distinct fluids present in the log in each column and matrix H_{N} contains the corresponding volume fractions of the different components at each depth. N denotes the number of factors, that is, expected fluids. Mathematically, V is approximated with V_{N}.

$$V \approx {V}_{N} = {W}_{N} {H}_{N} \qquad Equation ( 13 )$$

There are several typical matters with respect to a data matrix V that do affect our analyses. First, the matrix could be considered on per rock type basis. Namely, for each rock type a separate V is built and only depths belonging to that rock type go into that V. Subsequently, each data matrix is analyzed independently. Rock types may be chosen with any classification method used in the industry. These types are typically chosen based on geology. Second, the T1-T2 dimensionality of V can be decreased, because certain T1-T2 pairs do not correspond to any fluid expected to be observed. This can happen because such fluids do not exist, or the NMR tool is not sensitive to them. Such elimination can be done either pre-acquisition of V based on tool properties or post-acquisition based on average bin porosity of T1-T2 points. All procedures described below are done in the same way for data matrices built on a per-rock type basis with possibly excluded T1-T2 points.

In embodiments, misfit characteristics of the factorization are computed. One of them is a relative residual “unexplained” variance

$${U}_{N} = \frac{Var ( V - {V}_{N} )}{Var V} . \qquad Equation ( 14 )$$

where variance Var is taken through all T1-T2 and all depth indices. Misfit characteristics can also be computed for each depth d. It is proposed to use characteristics based on a relative misfit norm.

$${R}_{N} ( d ) = \frac{{{L}^{2} ( V - {V}_{N} )}^{d}}{{L}^{2} {V}^{d}} \qquad Equation ( 15 )$$

In this formula super-script d indicates a depth index of the corresponding matrix and L² is an Euclidean norm of a vector. Let's consider any data matrix A^{td}. It has depth index d and index t corresponding to T1-T2 relaxation times. Then Euclidean norm at a certain depth d is defined as

$${L}^{2} {A}^{d} = \sqrt{{\sum }_{∀ t} {( {A}^{td} )}^{2}} . \qquad Equation ( 16 )$$

To get a single characteristic out of R_{N}(d) for the entire depth interval percentiles that may be used include:

$${R}_{N}^{p} = percentile ( {R}_{N} ( d ) , p ) . \qquad Equation ( 17 )$$

Below the values median

$${R}_{N}^{50}$$

and 90th percentile

$${R}_{N}^{90}$$

are used. These misfit characteristics, especially the 90th percentile, emphasize the transition from signal bearing factors to ones corresponding to noise.

Any other misfit characteristics can be computed and used for the purposes of determining proper number of factors. Norms other than Euclidean can be used in equation 15. Additionally relative total porosity misfit can be used.

$${ϕ}_{N} ( d ) = \frac{\vert {\sum }_{∀ t} {( V - {V}_{N} )}^{td} \vert}{\vert {\sum }_{∀ t} {V}^{td} \vert} , {ϕ}_{N}^{p} = percentile ( {ϕ}_{N} ( d ) , p ) \qquad Equation ( 18 )$$

All these misfit characteristics can be used in place and in addition to

$${R}_{N}^{90} , {R}_{N}^{50} ,$$

and U_{N}. The focus is put on these 3 values.

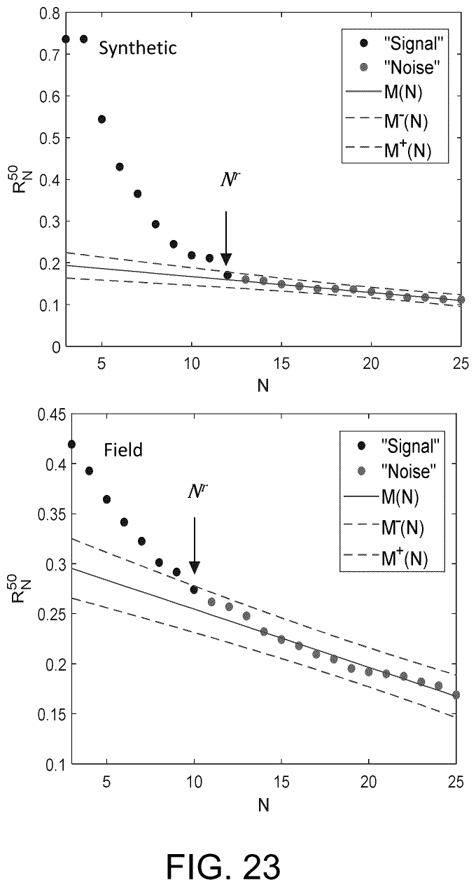

A method is developed to determine a recommended number of factors N^{r} together with confidence intervals M⁺(N) and M⁺(N) for the above-mentioned types of misfits. This procedure based on regression analysis is illustrated in FIG. 23. BSS factor maps W_{N} together with upper confidence intervals values M⁺(N) for various kinds of misfits are stored for use in further analyses.

As discussed above, BSS factors frequently possess “ghost” fluid signatures and therefore cannot be used per se.

As discussed above, the relationship M_{N}≥N is assumed because individual BSS factors W_{N} are linearly independent as a rule. Commonly, non-negativity of projection coefficients \tilde{H}_{M}_{_{N}}≥0 is required.

A particular way of refinement that is used herein is the value WLS. In WLS relationships (Equation 10) between BSS factors and WLS clusters—that are individual fluid signatures. These values are simply sums and coefficient in \tilde{H}_{M}_{_{N}} are either zeros or ones.

Once decomposition is established, the data matrix approximation is defined as shown above using Equation 11.

Afterwards, misfit characteristics

$${\tilde{R}}_{N}^{90} , {\tilde{R}}_{N}^{50} ,$$

and Ũ_{N} are defined according to relationships Equations (14)-(17) in which approximation V_{N} is substituted by refined approximation \tilde{V}_{N}. Any other refined misfits are defined using this substitution as well.

### Application of the Reference Dataset Results for a New Set of NMR Maps

Here the T1-T2 maps corresponding to the entire new log are denoted as a data matrix V′. One would like to seek for decomposition similar to one in Equation 13 in the form of the following equation:

$${V}^{′} \approx {V}_{N}^{′} = {W}_{N} {H}_{N}^{′} . \qquad Equation ( 19 )$$

Note that factors Wy in Equation 21 are the same as in Equation 1 while the weights

$${H}_{N}^{′}$$

are different. If new weights

$${H}_{N}^{′}$$

are established,

$${H}_{N}^{′}$$

can be reused in all previously established relationships by substituting H_{N} with

$${H}_{N}^{′}$$

and V with V′. All decompositions that can be used for fluid characterization particularly one based on fluid interpretation mask. Misfits calculated with new weights can be used for quality control as described below.

A method is described to determine new weights

$${H}_{N}^{′}$$

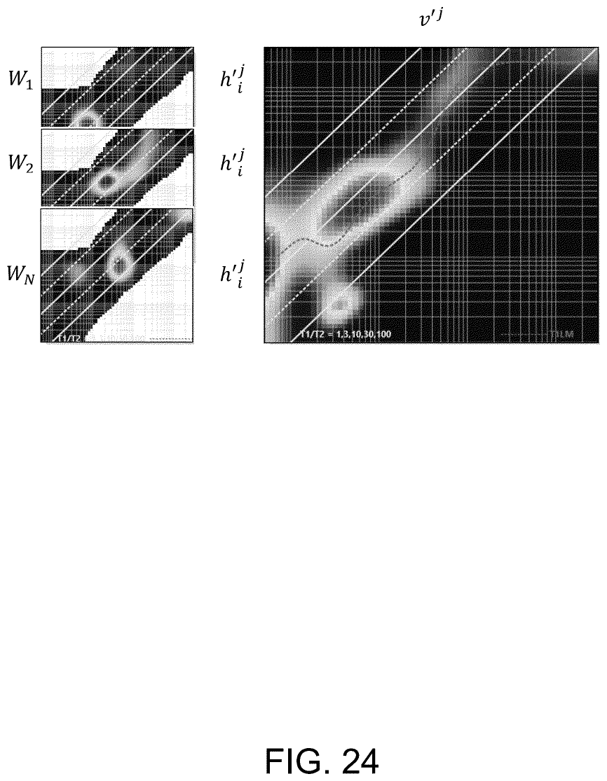

based on per-depth projection, that is minimizing misfit between maps and linear composition of factors W_{N} on per-depth basis as shown on FIG. 24.

Note that in FIG. 24 and in the equations below, lowercase designations v′^{j} denotes a new dataset NMR maps, while

$${h}_{i}^{′ j}$$

denote new factor weights on depth-per-depth basis. Upper index j is the depth index while lower index i corresponds to the reference dataset BSS factor Wᵢ.

Precisely

$${h}_{i}^{′ j}$$

are determined via minimization with non-negativity constraints performed on depth-per-depth basis.

$$‖ {v}^{′ j} - {\sum }_{i = 1}^{N} {h}_{i}^{′ j} {W}_{i} ‖ \to min \vert {h}_{i}^{′ j} \geq 0 , ∀ i , j \qquad Equation ( 20 )$$

Note that the norm in Equation 22 can be any norm widely used in the industry. Particularly, L2-norm is the most widely used. As a rule, the norm should be the same one as used in the non-negative matrix factorization, i.e. BSS, for the reference dataset; however, L1 norm can be used as well. After all minimizations for all depths are performed the whole

$${h}_{i}^{′ j}$$

for all depths constitutes the new weights matrix

$${H}_{N}^{′}$$

and all the interpretation procedures and misfits' calculations according to formulas in Equations 14 to 20, are carried out as described above.

### Quality Control and Further Analysis of the Results

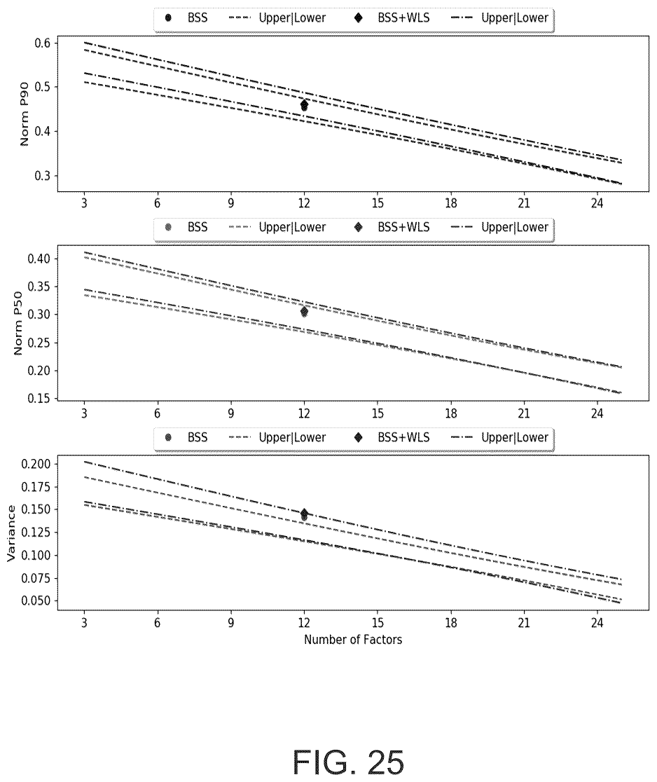

By comparison of misfits determined for new factors with upper confidence levels established on the reference dataset, quality control is established. If the misfits do not exceed those confidence levels, the procedure is successful and results can be used further with assurance. This case is illustrated in FIG. 25.

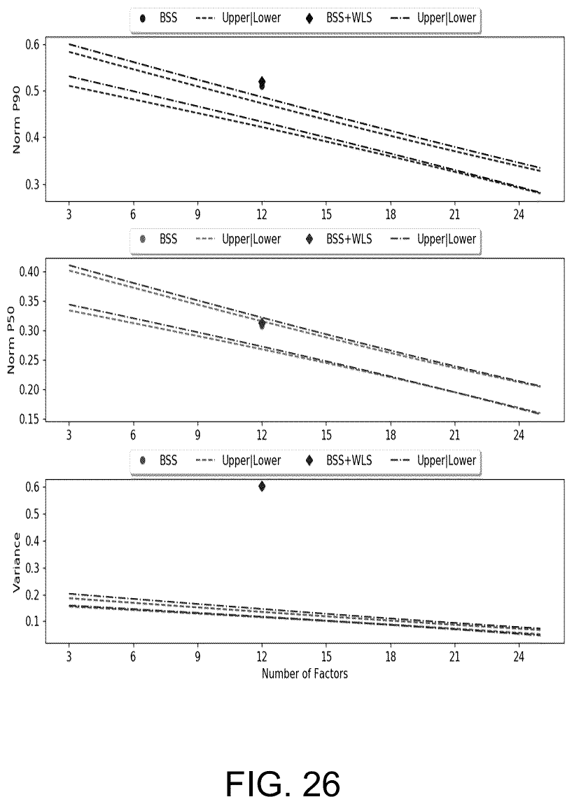

In the case when new misfits exceed the upper confidence levels established for the reference dataset, the results do not deliver surety and additional analysis is needed. This case is illustrated in FIG. 26.

In the case of failure, one way of possible improvement is to change the number of factors chosen. Starting with the previously determined recommended number of factors N^{r}, if this number demonstrates failure, vary the number of factors around NT and determine if it is possible to achieve successful results.

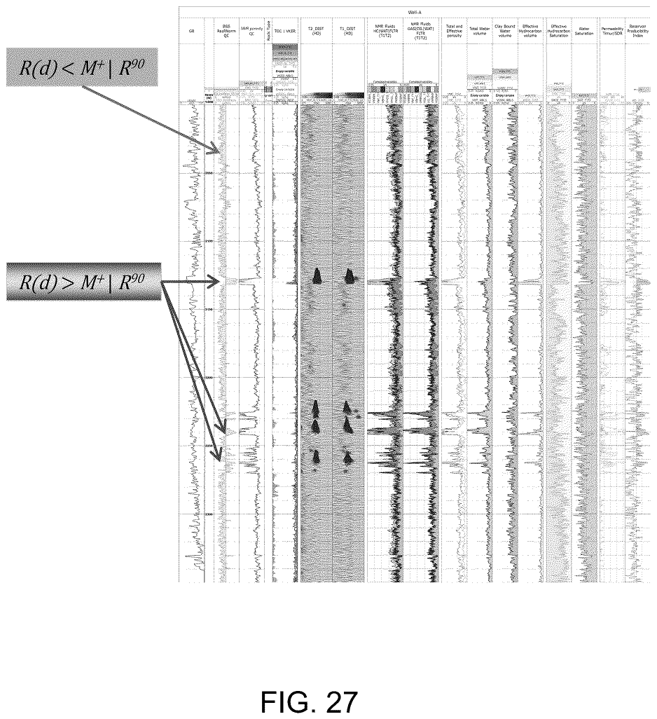

Another possible way of analysis is zoning of the new dataset and attempt to discover the possibility of success for certain zones of the new dataset. To facilitate the zoning, consider the per-depth misfit R(d) in comparison with the upper confidence limit for misfit 90th percentile M⁺|R⁹⁰. Such comparison is presented in FIG. 27 using the build data from FIG. 26. Note that per depth misfit values generally do not exceed the upper confidence level. The places where misfit exceeds this level are clearly zones of other petrophysical nature based on other data (perhaps washouts). Such zones can be excluded and analysis for the rest would be successful. Note that FIG. 26 gives indication that exclusion of outlier zones can lead to success. It is demonstrated by the fact that a median based misfit (middle plot) that is robust to outliers does not exceed confidence while 90th percentile (upper plot) and variance-based values (bottom plot) do exceed the confidence value. Variance based estimates are known to be the most prone to outliers among the 3 used; therefore, the bottom plot designates the worst quality.

If changing the number of factors and zonation does not deliver success, the entire factorization procedure (i.e., BSS, WLS and number of factors determination) may be performed for the new dataset from start.

### Applicability to Data Obtained By Other Inversions, Data Processing, Factorization, and Factorization Refinement Methods

In the present disclosure, the example of NMR T1-T2 logging interpretations provided are used, which uses non-negative matrix factorization with subsequent clustering to explain and illustrate the method. The method described; however, applies equally to data acquired by any NMR logging tool processed by any inversion with subsequent factorization and post-factorization refinement to obtain factors corresponding to individual fluids. Particularly, the method applies equally regardless of the dimensionality of the output. For instance; the method applies to one dimensional T2, T1 or diffusion measurement and inversion schemes, to two dimensional T1 and diffusion (or T2 and diffusion) measurement and inversion schemes, and to three dimensional T1, T2, and diffusion measurement and inversion schemes. It also applies to other factorization methods, such as principal component analysis, and various post-factorization refinement methods, as soon as the combined method delivers a series of approximations V_{N} of the original data V for a given number of factors or components N. It is these approximations that constitute a starting point for the analysis.

Present embodiments include a method comprising: i) choosing a dataset as a reference; ii) performing blind source separation (BSS) with non-negative matrix factorization, followed by water level separation (WLS) on the reference dataset; iii) calculating residual misfits for each number factors; iv) analyzing the residual misfits; v) determining recommended number of factors; vi) calculating confidence intervals for the residual misfits; vii) comparing the residual misfits with the calculated confidence interval; and vii) determining non-negative weights for the determined BSS factors and feasibly WLS clusters. The determined misfits stay below upper levels of confidence, the non-negative weights are used together with the previously determined factors in the same way as in ab initio procedure. The determined misfits may exceed upper levels of confidence, several ways of advancing analysis are possible, comprising: increasing the number of factors and comparing respective misfits with respective confidence intervals until success; per-depth misfit is calculated on new maps and compared with upper confidence to delineate outlier zones; or if outlier zones may not be separated from analysis, the procedure restarts with newly acquired data ab initio. The dataset has an ample set of logs in addition to NMR 2D maps. Step (ii) is performed on the reference dataset NMR maps for different number of factors starting from 3 to a large number, well exceeding maximum number of fluids to expect in a formation. Present embodiments may include a system comprising: a processor; memory accessible to the processor; and processor-executable instructions stored in the memory and executable by the processor to instruct the system to: i) choose a dataset as a reference; ii) perform blind source separation (BSS) with non-negative matrix factorization, followed by water level separation (WLS) on the reference dataset; iii) calculate residual misfits for each number factors; iv) analyze the residual misfits; v) determine recommended number of factors; vi) calculate confidence intervals for the residual misfits; vii) compare the residual misfits with the calculated confident interval; and viii) determine non-negative weights for the determined BSS factors and feasibly WLS clusters. The determined misfits may stay below upper levels of confidence; the non-negative weights are used together with the previously determined factors in the same way as in ab initio procedure. The determined misfits may exceed upper levels of confidence, several ways of advancing analysis are possible, comprising: increasing number of factors and comparing respective misfits with respective confidence intervals until success; per-depth misfit is calculated on new maps and compared with upper confidence to delineate outlier zones; or if outlier zones may not be separated from analysis, the procedure restarts with newly acquired data ab initio.

The dataset has an ample set of logs and possibly core in addition to NMR 2D maps. Step ii) is performed on the reference dataset NMR maps for different number of factors starting from 3 to a large number, well exceeding maximum number of fluids to expect in a formation.

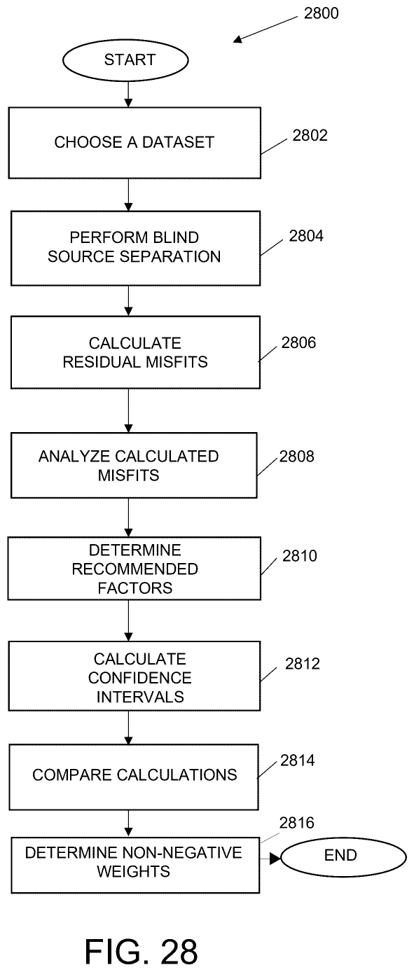

Referring to FIG. 28, a method 2800 is disclosed. The method may comprise, at 2802, i) choosing a dataset as a reference. The method may also comprise, at 2804, ii) performing blind source separation with non-negative matrix factorization, followed by water level separation on the reference dataset. The method may also comprise, at 2806, iii) calculating residual misfits for each number factor. The method may also comprise, at 2808, iv) analyzing the calculated residual misfits. The method may also comprise, at 2810, v) determining a recommended number of factors. The method may also comprise, at 2812, vi) calculating confidence intervals for the calculated residual misfits. The method may also comprise, at 2814, vii) comparing the calculated residual misfits with the calculated confidence intervals. The method may also comprise, at 2816, viii) determining non-negative weights for the determined blind source separation factors and feasibly water level separation clusters.

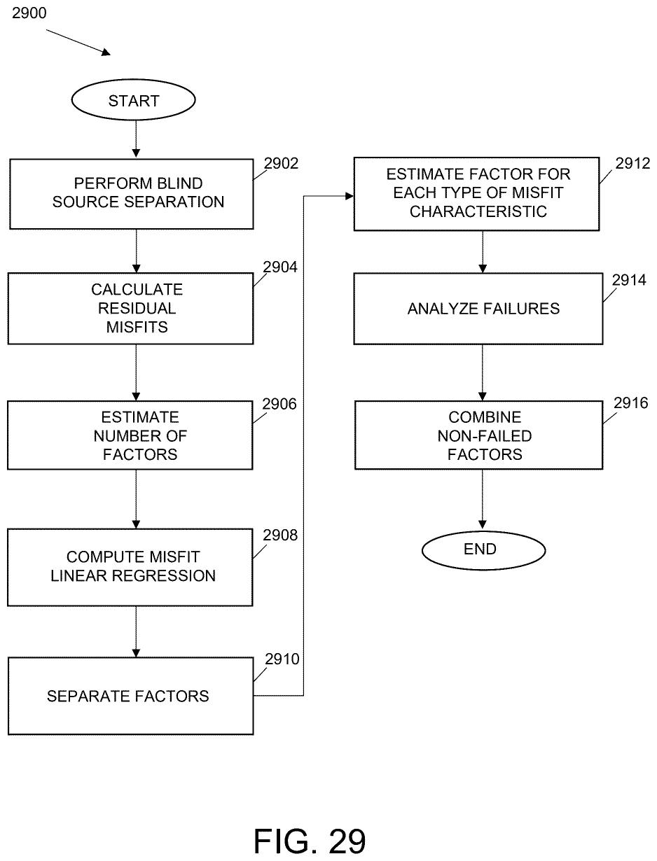

Referring to FIG. 29, a second method 2900 is disclosed. The method may comprise, at 2902, performing a blind source separation technique for a different number of factors. The method may further comprise, at 2904, calculating residual misfits for the different number of factors, wherein several types of misfit characteristics in addition to residual variance are calculated. The method may further comprise, at 2906, estimating a number of factors for each type of misfit characteristics via exhausting the entire useful signal. The method may further comprise, at 2908, computing a misfit linear regression for the number of factors corresponding to noise with regression confidence intervals. The method may further comprise, at 2910, based on the regression confidence intervals, separating factors corresponding to fluids from the factors corresponding to a noise. The method may further comprise, at 2912, estimating a proper number of factors for each type of misfit characteristic. The method may further comprise, at 2914, analyzing failures from the estimated proper number of factors. The method may further comprise, at 2916, combining all non-failed proper number of factors for all misfit types with one of refined and non-refined factors.

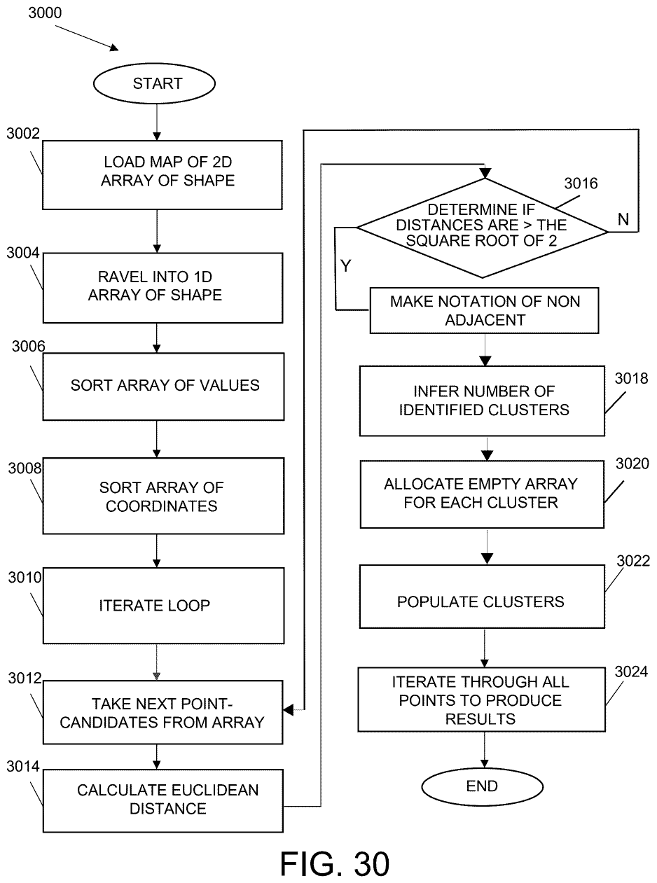

Referring to FIG. 30, a third method 3000 is disclosed. The method may comprise, at 3002, loading a map as a two-dimensional array of shape. The method may further comprise, at 3004, raveling the array into a one-dimensional array of shape. The method may further comprise, at 3006, sorting the array by values from highest to lowest. The method may further comprise, at 3008, sorting an array of original coordinates by a same sorting order as the sorting of the array by values from highest to lowest. The method may further comprise, at 3010, iterating, in a loop, through all remaining pair-values in the original coordinate array. The method may further comprise, at 3012 taking next point-candidates from the original coordinate array. The method may further comprise, at 3014 calculating a Euclidean distance between a new 2-value coordinate point candidate to all coordinate points in a summit array. The method may further comprise, at 3016 determining if the Euclidean distances calculated are greater than a square root of 2 and when such determination is true, then noting that a candidate is not adjacent to any previously identified island-summits and when the Euclidean distances calculated are not true, proceeding to a next point in the array of original coordinates. The method may further comprise, at 3018 inferring a number of identified clusters. The method may further comprise, at 3020 allocating an empty array for each identified cluster. The method may further comprise, at 3022, populating every identified cluster with a single point-coordinate of a cluster summit from a summit array. The method may further comprise, at 3024 iterating through all points in the original coordinate array to produce results.

Example embodiments of the claims are described next. The described embodiments should not be considered limiting of the disclosure. In one example embodiment, a method for analyzing a two dimensional nuclear resonance map is disclosed. The method may comprise choosing a dataset as a reference. The method may further comprise performing blind source separation with non-negative matrix factorization, followed by water level separation on the reference dataset. The method may further comprise calculating residual misfits for each number factor. The method may further comprise analyzing the calculated residual misfits. The method may further comprise determining a recommended number of factors. The method may further comprise calculating confidence intervals for the calculated residual misfits. The method may further comprise comparing the calculated residual misfits with the calculated confident intervals. The method may further comprise determining non-negative weights for the determined blind source separation factors and feasibly water level separation clusters.

In another example embodiment, the method may be performed wherein in an event the misfits stay below at least one upper level of confidence, the non-negative weights are used together with the previously determined blind source separation factors in a same way as in an ab initio procedure.

In another example embodiment, the method may be performed wherein in an event determined misfits exceed upper levels of confidence, analysis comprises: one of increasing a number of factors and comparing respective misfits with respective confidence intervals until success. The method may also comprise calculating per-depth misfit on new maps and comparing the misfit with an upper confidence to delineate outlier zones; and when outlier zones are not separated from analysis, the method restarts with newly acquired data ab initio.

In another example embodiment, the method may be performed wherein the dataset has at least one set of logs.

In another example embodiment, the method may be performed wherein step (ii) is performed on a reference dataset NMR maps for a different number of factors starting from 3 to a number exceeding a maximum number of fluids expected in a formation.

In another example embodiment, the method may further comprise ix) saving the non-negative weights in a non-volatile memory.

In another example embodiment, the method may further comprise x) displaying the non-negative weights in a non-volatile memory.

In another example embodiment, a method is disclosed. The method may comprise performing a blind source separation technique for a different number of factors. The method may further comprise calculating residual misfits for the different number of factors, wherein several types of misfit characteristics in addition to residual variance are calculated. The method may further comprise estimating a number of factors for each type of misfit characteristics via exhausting the entire useful signal. The method may further comprise computing a misfit linear regression for the number of factors corresponding to noise with regression confidence intervals. The method may further comprise based on the regression confidence intervals, separating factors corresponding to fluids from the factors corresponding to a noise. The method may further comprise estimating a proper number of factors for each type of misfit characteristic. The method may further comprise analyzing failures from the estimated proper number of factors. The method may further comprise combining all non-failed proper number of factors for all misfit types with one of refined and non-refined factors.

In another example embodiment, the method may be performed wherein the different number of factors starts from 3 to a number exceeding a maximum number of fluids expected in a formation.

In another example embodiment, the method may be performed wherein the combining the all non-failed proper number of factors for all misfit types with the refined or the non-refined factors is done by taking a median of each factor.

In another example embodiment, the method may be performed wherein the blind source separation factors are refined further to obtain additional misfits via one of a clustering method and a Gaussian fitting method.

In another example embodiment, the method may further comprise saving the combined non-failed proper number of factors for all misfit types with the one of the refined and the non-refined factors in a non-volatile memory.

In another example embodiment, the method may further comprise displaying the combined non-failed proper number of factors for all misfit types with the one of the refined and the non-refined factors.

In another example embodiment, a method is disclosed. The method may comprise loading a map as two-dimensional array of shape. The method may further comprise raveling the array into a one-dimensional array of shape. The method may further comprise sorting the array by values from highest to lowest. The method may further comprise sorting an array of original coordinates by a same sorting order as the sorting of the array by values from highest to lowest. The method may further comprise iterating, in a loop, through all remaining pair-values in the original coordinate array. The method may further comprise taking next point-candidates from the original coordinate array. The method may further comprise calculating a Euclidean distance between a new 2-value coordinate point candidate to all coordinate points in a summit array. The method may further comprise determining if the Euclidean distances calculated are greater than a square root of 2 and when such determination is true, then noting that a candidate is not adjacent to any previously identified island-summits and when the Euclidean distances calculated are not true, proceeding to a next point in the array of original coordinates. The method may further comprise inferring a number of identified clusters. The method may further comprise allocating an empty array for each identified cluster. The method may further comprise populating every identified cluster with a single point-coordinate of a cluster summit from a summit array. The method may further comprise iterating through all points in the original coordinate array to produce results.

In another example embodiment, the method may be performed wherein the raveling the array into the one-dimensional array is done one of column-wise and row-wise.

In another example embodiment, the method may further comprise noting the original 2D coordinates in a separate array of shape after the raveling the array into the one-dimensional array one of column-wise and row-wise.

In another example embodiment, the method may further comprise saving the results in a non-volatile memory.

In another example embodiment, the method may further comprise displaying the results.

In another example embodiment, the method may be performed wherein the method is a fluid interpretation mask method.

In another example embodiment, the method may be performed wherein the map is obtained through nuclear magnetic resonance evaluations.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A method for analyzing a two dimensional nuclear resonance map comprising:
i) choosing a dataset as a reference;
ii) performing blind source separation with non-negative matrix factorization, followed by water level separation on the reference dataset;
iii) calculating residual misfits for each number factor;
iv) analyzing the calculated residual misfits;
v) determining a recommended number of factors;
vi) calculating confidence intervals for the calculated residual misfits;
vii) comparing the calculated residual misfits with the calculated confident intervals; and
viii) determining non-negative weights for the determined blind source separation factors and feasibly water level separation clusters.

2. The method according to claim 1, wherein in an event the misfits stay below at least one upper level of confidence, the non-negative weights are used together with the previously determined blind source separation factors in a same way as in an ab initio procedure.

3. The method according to claim 1, wherein in an event determined misfits exceed upper levels of confidence, analysis comprises:
one of increasing a number of factors and comparing respective misfits with respective confidence intervals until success;
calculating per-depth misfit on new maps and comparing the misfit with an upper confidence to delineate outlier zones; and
when outlier zones are not separated from analysis, the method restarts with newly acquired data ab initio.

4. The method according to claim 1, wherein the dataset has at least one set of logs.

5. The method according to claim 1, wherein step ii) is performed on a reference dataset NMR maps for a different number of factors starting from 3 to a number exceeding a maximum number of fluids expected in a formation.

6. The method according to claim 1, further comprising:
ix) saving the non-negative weights in a non-volatile memory.

7. The method according to claim 6, further comprising:
x) displaying the non-negative weights in a non-volatile memory.

8. A method comprising:
performing a blind source separation technique for a different number of factors;
calculating residual misfits for the different number of factors, wherein several types of misfit characteristics in addition to residual variance are calculated;
estimating a number of factors for each type of misfit characteristics via exhausting the entire useful signal;
computing a misfit linear regression for the number of factors corresponding to noise with regression confidence intervals;
based on the regression confidence intervals, separating factors corresponding to fluids from the factors corresponding to a noise;
estimating a proper number of factors for each type of misfit characteristic; analyzing failures from the estimated proper number of factors; and
combining all non-failed proper number of factors for all misfit types with one of refined and non-refined factors.

9. The method according to claim 8, wherein the different number of factors starts from 3 to a number exceeding a maximum number of fluids expected in a formation.

10. The method according to claim 8, wherein the combining the all non-failed proper number of factors for all misfit types with the refined or the non-refined factors is done by taking a median of each factor.

11. The method according to claim 8, wherein the blind source separation factors are refined further to obtain additional misfits via one of:
a clustering method; and
a Gaussian fitting method.

12. The method according to claim 8, further comprising:
saving the combined non-failed proper number of factors for all misfit types with the one of the refined and the non-refined factors in a non-volatile memory.

13. The method according to claim 12, further comprising:
displaying the combined non-failed proper number of factors for all misfit types with the one of the refined and the non-refined factors.

14. A method, comprising:
loading a map as a two-dimensional array of shape;
raveling the array into a one-dimensional array of shape;
sorting the array by values from highest to lowest;
sorting an array of original coordinates by a same sorting order as the sorting of the array by values from highest to lowest;
iterating, in a loop, through all remaining pair-values in the original coordinate array;
taking next point-candidates from the original coordinate array;
calculating a Euclidean distance between a new 2-value coordinate point candidate to all coordinate points in a summit array;
determining if the Euclidean distances calculated are greater than a square root of 2 and when such determination is true, then noting that a candidate is not adjacent to any previously identified island-summits and when the Euclidean distances calculated are not true, proceeding to a next point in the array of original coordinates;
inferring a number of identified clusters;
allocating an empty array for each identified cluster;
populating every identified cluster with a single point-coordinate of a cluster summit from a summit array; and
iterating through all points in the original coordinate array to produce results.

15. The method according to claim 14, wherein the raveling the array into the one-dimensional array is done one of column-wise and row-wise.

16. The method according to claim 15, further comprising:
noting the original 2D coordinates in a separate array of shape after the raveling the array into the one-dimensional array one of column-wise and row-wise.

17. The method according to claim 14, further comprising saving the results in a non-volatile memory.

18. The method according to claim 14, further comprising displaying the results.

19. The method according to claim 14, wherein the method is a fluid interpretation mask method.

20. The method according to claim 14, wherein the map is obtained through nuclear magnetic resonance evaluations.
